(19) United States
(12) Patent Application Publication
(10) Pub. No.: US 2012/0130830 A1
(43) Pub. Date: May 24, 2012

(54) Method, an apparatus and a computer program

(76) Inventors: Alastair Bannerman, London (GB); Ifti Akbar, London (GB)

(21) Appl. No.: 13/136,995

(22) Filed: Aug. 16, 2011

Related U.S. Application Data
(60) Provisional application No. 61/401,637, filed on Aug. 16, 2010.
(60) Provisional application No. 61/458,646, filed on Nov. 29, 2010.

(51) Int. Cl. G06Q 30/02

(52) U.S. Cl. 705/14.72

(57) ABSTRACT

A method comprising: storing raw data relating to a carbon footprint of a media format; receiving a media plan for planning a media campaign, the media plan specifying the media format together with additional information relating to the media format; performing a calculation associated with the media format, the calculation using the additional information and the raw data related to the media format, the calculation generating a carbon index which indicates the carbon footprint associated with implementing the media format in the media plan. The present invention also relates to a corresponding apparatus and computer program.

### CROSS-REFERENCES TO RELATED APPLICATIONS

This application claims a benefit of priority under 35 U.S.C. 119(e) from co-pending provisional patent applications U.S. Ser. No. 61/401,637, filed Aug. 16, 2010 and U.S. Ser. No. 61/458,646, filed Nov. 29, 2010, the entire contents of both of which are hereby expressly incorporated herein by reference for all purposes. This application is related to, and claims a benefit of priority under one or more of 35 U.S.C. 119(a)-119(d) from co-pending United Kingdom Patent Application No. 1013795.8 filed on Aug. 17, 2011 under the Paris Convention, the entire contents of which are hereby expressly incorporated herein by reference for all purposes.

### TECHNICAL FIELD OF THE INVENTION

The present invention relates to a method, an apparatus and a computer program, and in particular, a method, an apparatus and a computer program for establishing a carbon footprint of a media plan.

### BACKGROUND TO THE INVENTION

It is known to generate a media plan in order to define and schedule an advertising campaign. Media plans typically specify how different media formats are to be used in the campaign. For example, the media plan may specify the use of various outdoor media formats, such as, for example, posters, digital signage or billboards. Additionally or alternatively, the media plan may specify other media formats, such as, for example, press, internet, television, radio and the like.

For each specific media format, the media plan may also specify some additional information relating to how that format will be used in the advertising campaign. For example, the media plan may specify the size and quantity of each media format, for example, a size and number of posters to be displayed. Additionally or alternatively, the media plan may specify the regionality of each media format, for example, a television advertising campaign may cover the whole of a particular country whereas a digital signage campaign may only cover the public transport of a particular city. Additionally or alternatively, the media plan may specify a duration for each media format, for example, a television campaign may run for a number of weeks whereas a poster campaign may run for a number of months.

The process of planning, designing and implementing each different media format incurs the production of an amount of carbon dioxide (CO2). Various factors will influence the production of CO2 in respect of each different media format. Considering the poster media format, the production of the poster at a factory will incur a certain amount of CO2 production, for example, the factory will require lighting and heating and the factory machinery will require electricity. Also, the act of transporting the poster from a manufacturing facility to a use site will incur the production of CO2 since a certain amount of fuel will be used by the transporting vehicle. Different media formats can cause different amounts of CO2 to be produced, and the CO2 production rate can vary between different media formats.

In view of the above, each media format specified within a media plan involves the production of a certain amount of CO2 over the course of the advertising campaign. Therefore, the media plan itself can be associated with the production of CO2 over the duration of the plan, i.e. the carbon footprint of the media plan. The greater the production of CO2 caused by the media plan, the greater affect the media plan has on the environment and therefore, the greater its carbon footprint. Specifically, the estimated amount of CO2 generated by a media plan will be equal to the combined estimated CO2 produced by each media format in the media plan, i.e. the combined carbon footprint of each media format. The amount of CO2 related to each different media format will be a function of its type, its quantity and its duration.

It is an aim of the invention to provide a method of producing a media plan which provides the amount of CO2 produced for each separate media format specified in the media plan, and for the complete media plan.

It is known to provide a media plan which estimates a cost of each media format proposed in the media plan. It is also known to provide an overall cost estimate for implementing the complete media plan. However, it is not know to provide a media plan which provides a carbon footprint of the media plan.

### SUMMARY OF THE INVENTION

A first aspect of the present invention provides a method comprising: storing raw data relating to a carbon footprint of a media format; receiving a media plan for planning a media campaign, the media plan specifying the media format together with additional information relating to the media format; performing a calculation associated with the media format, the calculation using the additional information and the raw data related to the media format, the calculation generating a carbon index which indicates the carbon footprint associated with implementing the media format in the media plan.

Preferably, the raw data relating to the media format comprises a set of raw data elements, the additional information relating to the media format comprises a set of additional information elements, and the calculation associated with the media format comprises a series of calculations, each calculation using one of the raw data elements and one of the additional information elements.

Preferably, each raw data element relates to a carbon footprint of the media format during one stage in the life of the media format, and each calculation generates a carbon index for one stage in the life of the media format.

Preferably, a calculation is provided for each stage in the lifecycle of the media format and each calculation relates to only one stage in the lifecycle.

Preferably, the lifecycle stages include at least one of the following group: planning stage, design stage, production stage, transport stage, storage stage, installation stage, use stage, disposal stage.

Preferably, the raw data elements include at least one of the following group: the carbon dioxide produced in the planning stage per media format unit, the carbon dioxide produced in the production stage per media format unit, the carbon dioxide produced in the transport stage per media format unit, the carbon dioxide produced in the storage stage per media format unit, the carbon dioxide produced in the installation stage per media format unit, the carbon dioxide produced in the use stage per media format unit, the carbon dioxide produced in the disposal stage per media format unit.

Preferably, the additional information elements include at least one of the following group: a manufacturer, a size, a quantity, a regionality, a duration, a cost.

Preferably, the carbon footprint is an amount of carbon dioxide emitted.

Preferably, the raw data comprises data that estimates the carbon footprint of the media format.

Preferably, the raw data comprises data of the actual carbon footprint of the media format.

Preferably, the raw data is stored relating to one or more different media formats and the media plan specifies the one or more different media formats together with additional information for the one or more different media formats, and the step of performing a calculation is performed for at least one of the one or more different media formats.

Preferably, the step of performing a calculation is performed for each of the one or more different media formats.

Preferably, the method further comprises a step of combining the carbon index generated for each of the one or more different media formats to generate a carbon index for the complete media plan.

Preferably, the method further comprises comparing a generated carbon index with a corresponding carbon index relating to a different media plan, and generating an indicator which represents the result of the comparison.

Preferably, the method further comprises comparing a generated carbon index with an example carbon index, the example carbon index being related to performing a particular activity, and calculating a modified generated carbon index expressed in terms of the example carbon index.

A second aspect of the present invention provides an apparatus, comprising: a processor, memory including computer program code, the memory and computer program code configured in use to, with the processor, cause the apparatus to perform at least the following: store raw data relating to a carbon footprint of a media format; receive a media plan for planning a media campaign, the media plan specifying the media format together with additional information relating to the media format; perform a calculation associated with the media format, the calculation using the additional information and the raw data related to the media format, the calculation generating a carbon index which indicates the carbon footprint associated with implementing the media format in the media plan.

Preferably, the apparatus further comprises a display, the apparatus being further caused to display on the display the carbon index.

Preferably, the apparatus is further caused to compare the carbon index with a corresponding carbon index relating to a different media plan, and display on the display an indicator which represents the result of the comparison.

Preferably, the apparatus is further caused to compare the carbon index with an example carbon index, the example carbon index being related to performing a particular activity, and display on the display a modified carbon index expressed in terms of the example carbon index.

A third aspect of the present invention provides a computer program, comprising: code for storing raw data relating to a carbon footprint of a media format; code for receiving a media plan for planning a media campaign, the media plan specifying the media format together with additional information relating to the media format; code for performing a calculation associated with the media format, the calculation using the additional information and the raw data related to the media format, the calculation generating a carbon index which indicates the carbon footprint associated with implementing the media format in the media plan.

Preferably, the computer program is a computer program product comprising a computer-readable medium bearing a computer program code embodied therein for use with a computer.

A fourth aspect of the present invention provides a computer-readable medium encoded with instructions that, when executed by a computer: store raw data relating to a carbon footprint of a media format; receive a media plan for planning a media campaign, the media plan specifying the media format together with additional information relating to the media format; perform a calculation associated with the media format, the calculation using the additional information and the raw data related to the media format, the calculation generating a carbon index which indicates the carbon footprint associated with implementing the media format in the media plan.

The additional features stated above in respect of the first aspect are equally applicable to the second, third and fourth aspects.

### BRIEF DESCRIPTION OF THE DRAWINGS

Various example embodiments of the present invention will now be described with reference to the following drawings, wherein like reference numerals relate to like components.

FIG. 1 is a flow diagram of a method according to a first example embodiment of the present invention;

FIG. 2 is a flow diagram of a lifecycle according to the first embodiment;

FIG. 3 is a block diagram of a calculator according to the first embodiment;

FIG. 4 is a block diagram of a computer system according to a second example embodiment of the present invention;

FIG. 5 is a flow diagram of a lifecycle according to the second embodiment;

FIG. 6 is a block diagram of a calculator according to the second embodiment;

FIG. 7 is a flow diagram of the operation of the second embodiment;

FIG. 8 is a user interface according to a third embodiment of the present invention;

FIG. 9 is an event diagram related to the third embodiment;

FIG. 10 is a flow diagram of a lifecycle according to the third embodiment;

FIGS. 11 to 14 are block diagrams of calculators according to the third embodiment;

FIG. 15 is a representation of the CO2 emission values calculated by the third example embodiment;

FIG. 16 is another view of the user interface of FIG. 8;

FIGS. 17 to 18 are event diagrams related to alternative embodiments of the present invention;

FIGS. 19a and 19b are an event diagram relating to a fourth embodiment;

FIG. 20 is a flow diagram of a lifecycle according to the fourth embodiment;

FIGS. 21 to 31 are block diagrams of calculators according to the fourth embodiment;

FIG. 32 is an event diagram related to the fifth embodiment;

FIG. 33 is a flow diagram of a lifecycle according to the fifth embodiment;

FIGS. 34 to 37 are block diagrams of calculators according to the fifth embodiment; and

FIG. 38 is a user interface according to a sixth embodiment of the present invention.

### DETAILED DESCRIPTION OF EMBODIMENTS OF THE INVENTION

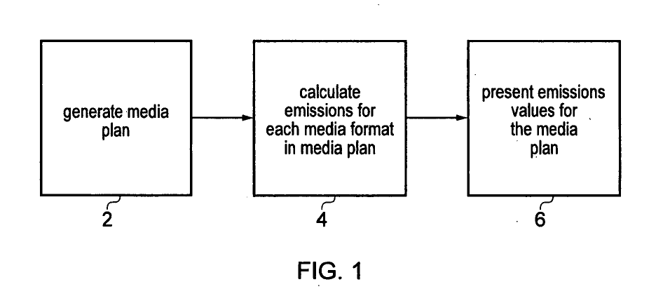

The following describes an example embodiment of a method according to the present invention, with reference to FIGS. 1 to 3.

FIG. 1 is a flow diagram of a method according to a first example embodiment of the present invention. The flow diagram of FIG. 1 begins at block 2 wherein a media plan is generated. The media plan generated specifies a number of different media formats or types to be used in an advertising campaign. Exemplary media formats include, but are not limited to, billboard posters, digital signs, internet adverts, television adverts, radio adverts, press adverts. In the media plan, additional information is included for each media format specified therein. For example, the individual additional information elements may specify: a manufacturer of the media format, a type of the media format, the quantity of those media formats in the media plan, the regionality of those media formats in the media plan, the duration or length of time those media formats will be used in the media plan, or a cost of having those media formats in the media plan. Additionally or alternatively, the media plan may specify an effectiveness of each media format, for example, a poster campaign in a local city may reach a certain size group of people whereas a national television advertising campaign may reach a larger size group of people. Once the media plan has been generated processing moves from block 2 to block 4. In block 4, an estimated CO2 emissions value is calculated for each media format in the media plan (i.e. a carbon footprint of each media format is calculated). Additionally at this stage, a total CO2 emissions value relating to the complete media plan (i.e. a carbon footprint of the complete media plan) is also calculated by combining the CO2 emissions values for each media format in the media plan. The specifics of this operation will be discussed in greater detail below. Once all the CO2 emissions values have been calculated, processing moves from block 4 to block 6. In block 6, the emissions values for each individual media format in the media plan, and the complete media plan, are presented. The emissions values therefore represent carbon indexes, i.e. a carbon index for each individual media format in the media plan, and a carbon index for the complete media plan. In practise, the CO2 emissions values may be presented to the person who input the media plan in block 2 to inform them of the environmental impact of their proposed media plan. The precise form of presentation may vary between different embodiments, for example, presentation may be via a spreadsheet, a graph or a list.

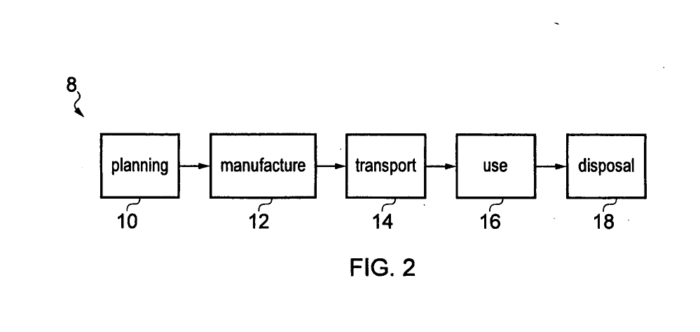

Considering block 4 in greater detail, FIG. 2 is a flow diagram of a lifecycle 8 of an exemplary media format specified in the media plan, such as, for example, a poster. The lifecycle 8 defines stages in the life of a poster from its creation to its disposal. Importantly however, each stage is chosen because the operations performed during that stage cause the production of CO2 as a by-product. In block 10, at the beginning of the lifecycle 8, the poster is planned at a media planning office and designed at a graphic design office. In block 12, the designed poster is manufactured at a manufacturing facility. In block 14, the manufactured poster is transported from the manufacturing facility to a use site. In block 16, the poster is installed at the use site and left there for the duration of the advertising campaign specified by the media plan. In block 18, at the end of the lifecycle 8, once the advertising campaign has finished the poster is removed from the use site and disposed of, for example, at a landfill site.

At each stage (10 to 18) in the lifecycle 8 of the poster the various actions and events occurring in that stage involve the production of CO2. For example, in block 10, the heating and lighting used in the planning and design offices will cause CO2 production. In block 12, the heating and lighting used in the manufacturing facility, together with the electricity used to run the manufacturing machinery, will cause CO2 production. In block 14, the use of fuel (e.g. petrol or diesel) by the transport vehicle in delivering the poster to the use site will cause CO2 production. In block 16, the energy used to illuminate the poster during use will cause CO2 production. In block 18, the transportation of the poster from the use site to a disposal site (e.g. a landfill or recycling facility) together with the energy required to dispose of the poster will cause CO2 production. It is to be understood that many different events may occur at each stage, each of which cause the production of CO2 as a by-product.

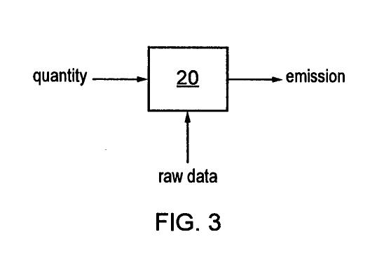

At each stage (10 to 18) in the lifecycle 8 an expression can be defined which determines the amount of CO2 emissions which are caused to be produced during that stage. FIG. 3 shows an exemplary expression embodied in a calculator 20. The calculator 20 relates to the block 10 of FIG. 2, i.e. the poster planning stage. The calculator 20 is configured to receive input values, perform a mathematical operation on those input values, and generate an output value. In the present example embodiment, the inputs are a quantity of posters of a particular format in the media plan, and some raw data relating to CO2 production during poster planning. Specifically, the individual raw data elements relate to the number of kilograms of CO2 produced to plan one poster at the planning office. For example, this figure may be obtained by calculating the total annual CO2 emissions by the planning office and then dividing that figure by the total number of posters planned in a year. Of course this assumes that the planning office's only operation is to plan posters. The operation of the calculator multiplies the raw data value with the number of posters in the media plan to generate a value for the amount of kilograms of CO2 produced in planning all the posters in the media plan. Accordingly, in the present example embodiment the calculator comprises a multiplication element. It is to be understood however that in other example embodiments different input values and raw data values can be used, and the calculators can perform different and more complex arithmetic operations. For example, considering the poster manufacturing stage (block 12), appropriate raw material values may be the number of kilograms of CO2 produced per poster in extracting, processing and transporting the paper, plastics, glue and ink for making the poster. It is also to be understood that this example embodiment is not limited by any particular expression for calculating CO2 emissions, and other methods are equally applicable. For example, the calculator may include operators other than or in addition to a multiplication element.

For each stage (10 to 18) in the lifecycle 8 of FIG. 2 there is provided a corresponding calculator which performs an operation which is specific to that stage in order to generate a CO2 emission value relating to the operations of that stage. Furthermore, each separate calculator will use raw data values which are specific to the corresponding stage in the lifecycle. A CO2 emission value is therefore generated for each stage (10 to 18) in the lifecycle 8. It is then possible to calculate a total CO2 emission value for one media format in the media plan, for example, a particular size of poster. This value is generated by combining the CO2 emission values for each of the stages (10 to 18) in the lifecycle 8 relating to posters of that particular size. According to this operation, it is possible to calculate a total CO2 emission value for one media format in the media plan. This operation can then be repeated for each other different media format specified in the media plan. Where the other media formats are different varieties of poster the lifecycle will be the same and, therefore, the process of calculating the CO2 emission values will be the same. However, where the other media formats are not different varieties of poster, a new lifecycle must be generated with a corresponding set of calculators and raw data values. According to this operation it is possible to generate a total CO2 emission value for each media format specified in the media plan. Furthermore, it is also possible to generate a total CO2 emission for the complete media plan to identify the carbon foot print of the media plan.

It is to be understood that although the above example embodiment considers a poster media format the above-described method is equally applicable to other media formats, such as, other outdoor media formats including, but not limited to, posters of different size or shape, illuminated posters, digital signage, backlit posters and rotating posters. Furthermore, the above method is also equally applicable to different categories of media format, such as, television advertising, radio advertising, internet advertising and the like. However, it is to be understood that the lifecycle 8 and its series of calculators and raw data values are specific to posters. If non-poster media formats are to be considered then a new lifecycle must be generated with a corresponding series of calculators and raw data values.

It is an advantage of the above-described example embodiment that the environmental impact of a proposed media plan can be quantified and assessed by considering the total CO2 emissions value for the media plan. Furthermore, the main sources of environmental damage within a single media plan can also be easily identified by identifying which media format in the media plan has the largest CO2 emissions value. Stated differently, it is possible to identify the carbon footprint of both the individual media formats in a media plan and the complete media plan.

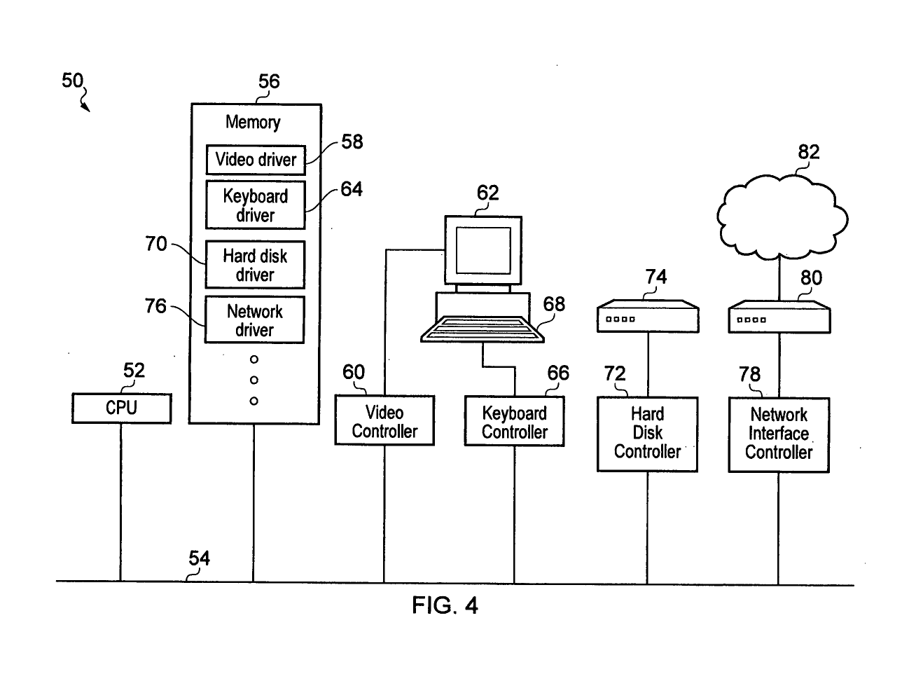

Next will be described an example embodiment of a computer system arranged to perform the above-described method, with reference to FIGS. 4 to 7.

FIG. 4 illustrates a simplified computer system architecture for a computer system 50. More particularly, the computer system 50 comprises a central processing unit (CPU) 52, which is arranged to communicate via a bus 54 with a memory, and various input and output devices, as well as other system resources, such as memory resources, and communications resources. More particularly, a memory 56 is provided, which would typically be random access memory (RAM), and which stores various programs to allow the computer system 50 to operate. In particular, as shown, the memory 56 may store a video driver program 58, which allows the computer system operating system (not shown) to communicate with a video controller 60, which controls an output video screen 62. A keyboard driver 64 is also stored in the memory 56, which allows the computer system operating system to communicate with a keyboard controller 66, which controls a keyboard 68. Similarly, a hard disk driver 70 is stored in the memory 56, which allows the operating system to communicate with a hard disk controller 72, which controls a hard disk 74. Likewise, a network driver 76 is also stored in the memory 56, which allows the operating system to communicate with a network interface controller 78, which controls a network card 80 to allow the computer system 50 to communicate with other computer systems via a network 82. In order to allow the computer system to operate, as shown the various device drivers must be stored in the memory 54, to allow user processes to access or control the various system resources, as well as to obtain information as to one or more properties of the various system resources, such as, for example, hard disk capacity, network connection speed, video screen resolution, or the like. The device drivers 58, 64, 70 and 76 must therefore contain code to allow for access and/or control of the respective system resources, as well as to provide notification of one or more properties of the system resources to other requesting processes running on the computer system.

The computer system 50 is configured to receive an input from a user via the keyboard 68, and to provide an output to the user via the display 62. In operation, the computer system 50 receives an input from the user which specifies a media plan. The input is then used by the CPU 52 in combination with raw data stored on the hard disk 74 to calculate a CO2 emission value relating to each media format specified in the media plan. The CPU 52 is also configured to generate a CO2 emission value relating to the complete media plan. The following describes this process in greater detail.

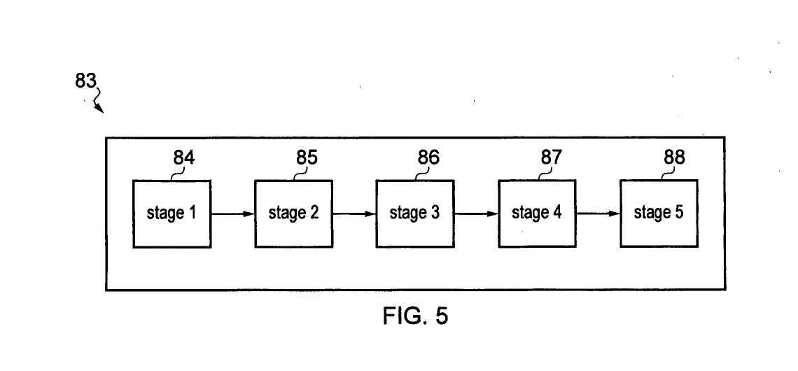

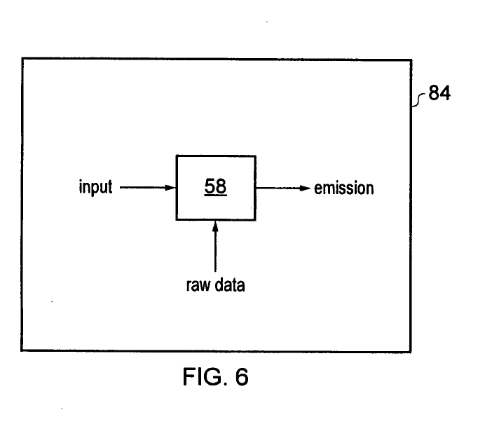

As mentioned previously, a media plan is provided by a user which specifies a number of different media formats to be used in an advertising campaign. The CPU 52 is configured to load into memory 56 a lifecycle for each different type of media format in the media plan. The lifecycles for each different media format are stored on the hard disk 74. As discussed previously, the lifecycle separates out each stage in the life of each media format, beginning with the planning and design of the media format and ending with the disposal of the media format after use. As seen more particularly in FIG. 5, an exemplary lifecycle 83 is shown comprising a plurality of individual stages 84 to 88. The lifecycle 83 relates to one media format type specified in the media plan input by the user, e.g. outdoor media including posters. The lifecycle 83 is analogous to the lifecycle 8 mentioned above. As before, each stage (84 to 88) of the lifecycle 83 is associated with a calculator. Each calculator is configured to receive inputs and operate on those inputs to generate an output. Accordingly, each calculator is a section of computer code stored in the memory of the computer system 50. When calculator code is run it causes the CPU 52 to perform a mathematical operation on the input values. FIG. 6 illustrates an exemplary calculator 58, which is analogous to the calculator 20 mentioned above. In the present example embodiment, the values input to the calculator 58 include inputs which the user provided to the via the keyboard 68, and raw data stored on the hard disk 74. Once run, the calculator 58 is configured to generate a CO2 emission value relating to the amount of CO2 generated in one stage in the lifecycle of one type of media format. For example, the calculator 58 may cause the CPU 52 to generate a CO2 emission value relating to the amount in kilograms of CO2 generated during the use of all the six-sheet type posters specified in the media plan. In this instance the raw data used by the calculator must relate to the use phase of six-sheet posters. Alternatively, the calculator 58 may cause the CPU 52 to generate a CO2 emission value relating to the amount in kilograms of CO2 generated during the manufacturing of six-sheet posters. In this case the raw data used by the calculator must relate to the manufacturing phase of six-sheet posters. Accordingly to this operation, the CPU 52 is configured to calculate a CO2 emission value for each stage (84 to 88) in the lifecycle 83 of one media format type specified in the media plan. This process can then be repeated for each of the other different media format specified in the media plan to generate CO2 values for each stage of each media format specified in the media plan. However, it is to be understood that the lifecycle 83 and its series of calculators and raw data values are specific to one category of media format, such as, for example, outdoor media formats including posters. If non-outdoor media formats (i.e. non-poster type media formats) are to be considered then a new lifecycle must be generated with a corresponding series of calculators and raw data values. This operation of the computer system 50 is analogous to the operation of the above-described method.

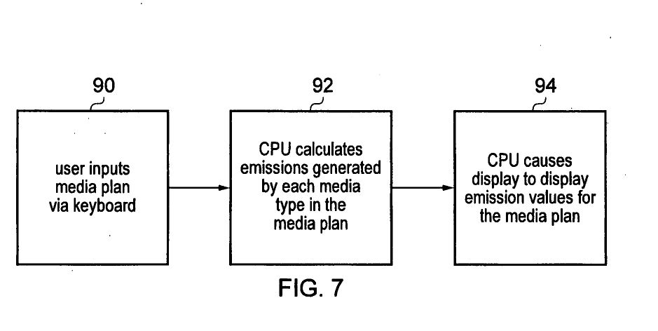

FIG. 7 illustrates the operation of the computer system 50 as a flow diagram. In block 90, the user inputs a media plan into memory 56 using the keyboard 68. As mentioned above, the media plan specifies which particular media formats are to be used, and defines further details relating to each media format. The further details may include, but are not limited to, a type of a particular media format, a quantity of the media format, a manufacturer of the media format, a regionality of the media format, or a duration of use of the media format, a cost of the media format. In block 92, the CPU 52 retrieves the input media plan from memory 56 and loads into memory 56 from hard disk 74 a lifecycle for the type of media format first listed in the media plan. Next, the CPU 52 is caused to calculate a CO2 emission value for each stage in the loaded lifecycle. As described above, this is achieved by a series of calculators associated with the lifecycle. In particular, a calculator is defined for each lifecycle stage, and each calculator is configured to cause the CPU 52 to generate a CO2 emission value using the data input by the user (i.e. the media plan) and lifecycle stage specific raw data which is stored on the hard disk 74. Each calculator is therefore configured to generate a CO2 emission value relating to its corresponding lifecycle stage.

Once emissions values have been calculated for each lifecycle stage of the first media format the values are stored in a memory of the computer system 50, such as, for example, the hard disk 74. This process is then repeated for the type of media format listed second in the media plan. Accordingly, CO2 emission values relating to the second listed media format are stored in memory with the values relating to the first listed media format. It is to be understood that the lifecycle and its associated calculators and raw data values are specific to particular types of media format. Therefore, each time the computer system 50 considers a type of media format which is not compatible with the current lifecycle, calculators, and raw data values, the computer system 50 loads a compatible lifecycle, calculators and raw data values from memory. The above process is continued until the CPU 52 has calculated and stored a complete set of CO2 emission values for each different media format specified in the media plan. At this point processing flows to block 94.

In block 94, the CPU 52 causes the display 62 to display to the user a total CO2 emission value for each different media format in the media plan. For example, the information may be displayed to the user in tabular form, graphical form, or list form. Additionally, the CPU 52 is configured to combine all the CO2 values relating to all the different media formats used in the media plan to generate a total CO2 emission value for the complete media plan. The CPU 52 is additionally configured to cause the display 62 to display the total CO2 emission value for the complete media plan with the other CO2 values.

According to the above-described example embodiment a computer system is provided that generates and displays CO2 emission values relating to an input media plan. It is an advantage of this example embodiment that an apparatus is provided to perform the above-described method. The advantages associated with the above-described method are also achieved by the present example embodiment.

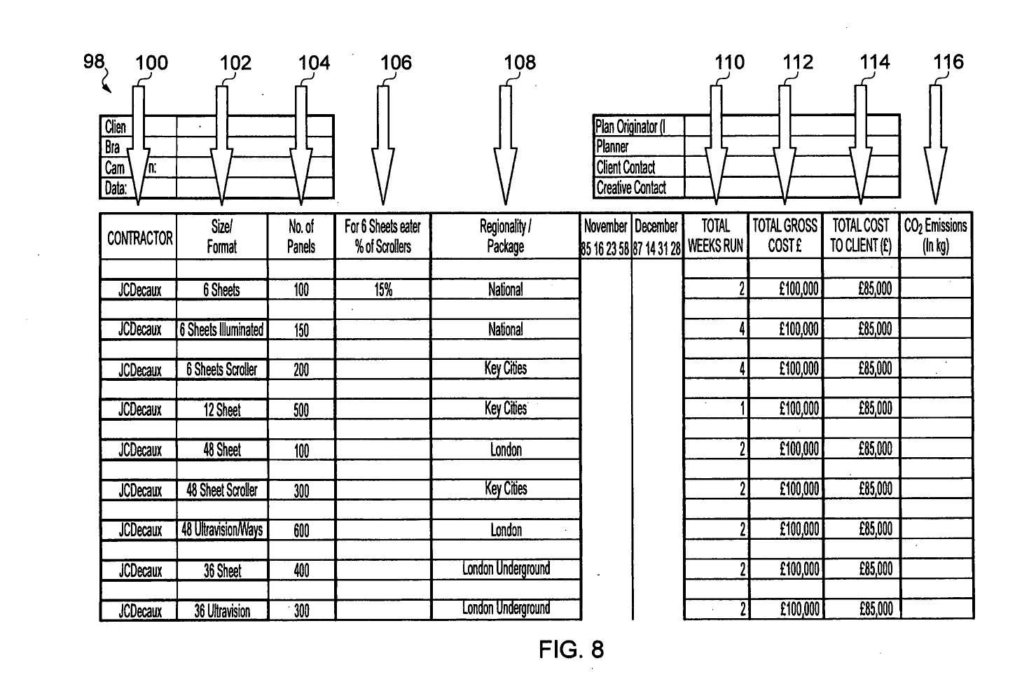

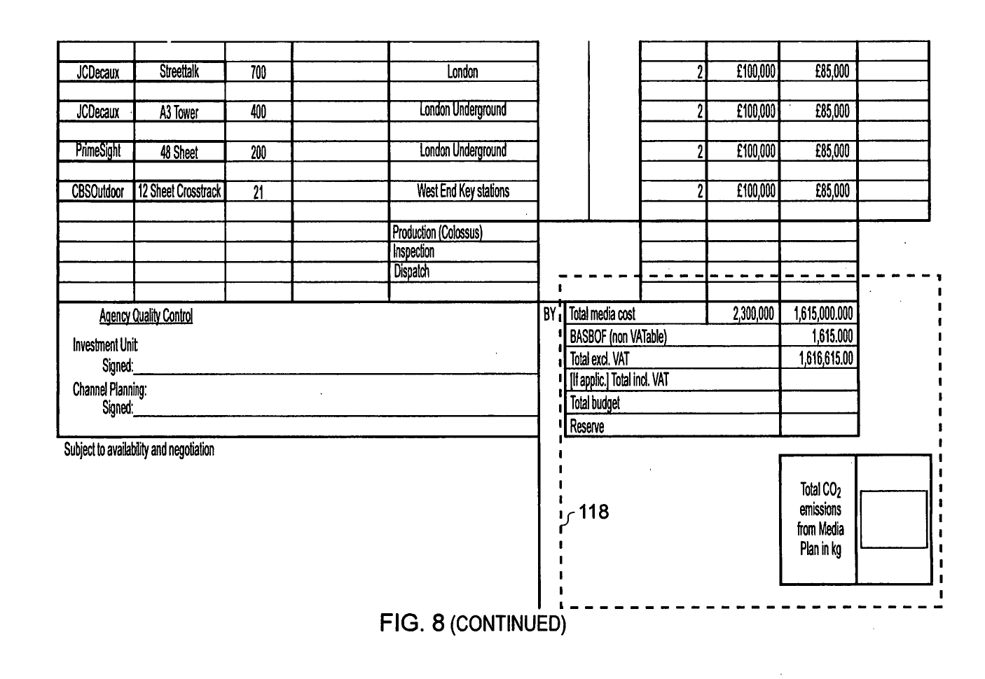

Next will be described a more detailed computer system example embodiment, with reference to FIGS. 8 to 16. The following example embodiment relates to a media plan which specifies a variety of different outdoor media formats, including but limited to, digital signage and billboards of differing sizes. FIG. 8 shows a user interface 98 to be displayed on display 62 by the computer system 50 of the present example embodiment. In use, a user of the computer system 50 provides inputs via the keyboard 68 to define a media plan using the user interface 98. The following describes the user interface 89 and indicates what information is required to be input where.

The user interface 98 is a spreadsheet comprising a number of rows and columns. Each row specifies all the additional (planning) information relating to one type of outdoor media format, such as, for example, a six-sheet poster. Each column specifies one outdoor media format attribute, which can be a characteristic of the outdoor media format, or a characteristic of the outdoor media format's use in the media plan. Column 100 specifies a manufacturer of the exemplary poster, wherein one of four different manufacturers can be selected. Column 102 specifies a type of the poster (i.e. a six-sheet), wherein the type typically comprises a size, however, additionally the type can specify other features. For example, possible poster types include, but are not limited to, six-sheets, twelve-sheets, forty-eight-sheets, and ninety-eight-sheets. Additional features which can be specified include, but are not limited to, illuminated, for scrolling billboards, backlit, and printed in high definition. Column 104 specifies a quantity of six-sheet posters in the media plan. Column 106 specifies for scrolling posters only, the percentage of the total scrolling area which is covered by the poster. Column 108 specifies a regionality of the six-sheet posters i.e. the size of region throughout which the media formats are to be displayed. Column 110 specifies a duration, i.e. how long the six-sheet posters are to be displayed for. Column 112 specifies a total gross cost of using the six-sheet posters in the media plan, whereas column 114 specifies a total cost to a client of using the posters in the media plan. It is to be understood that the user interface 98 is intended to be used by employees of a media planning office and therefore, in the instant case, the client is the customer for whom the media plan has been created for. Column 116 specifies the CO2 emissions produced by using the different outdoor media format types in the media plan. Finally, area 118 specifies various totals relating to the media plan including, but not limited to, the total cost of implementing the media plan, and the total CO2 emissions produced by implementing the media plan. It is to be understood that in some other embodiments different additional information relating to the media formats could be specified in the media plan. For example, in some embodiments the media plan may specify an effectiveness of each media format, for example, a poster campaign in a local city may reach a certain size group of people whereas a national television advertising campaign may reach a larger size group of people.

The user therefore uses the user interface 98 to specify a media plan. In particular, the user can specify, via the keyboard 68, which outdoor media formats are to be used and exactly how they are to be used. This operation is analogous to the operation described above relating to block 90 of FIG. 7.

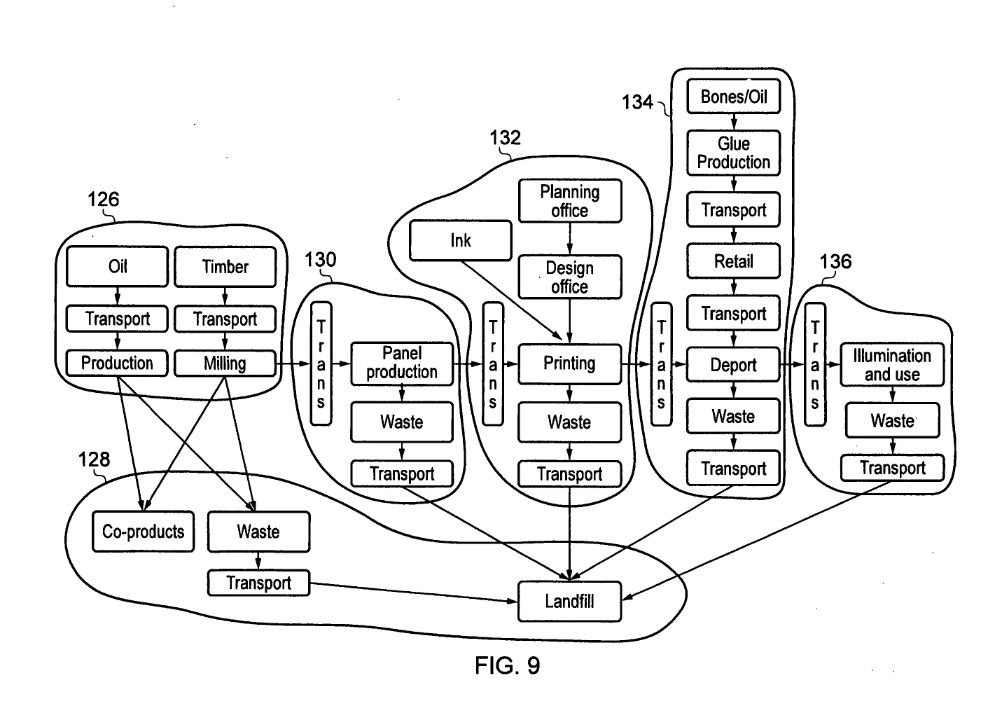

Once a media plan has been input by a user, the computer system according to the present example embodiment loads into memory the outdoor media lifecycle. As described above, the lifecycle breaks down the life of a outdoor media format into a series of events, wherein each event causes the production of CO2 as a by-product. FIG. 9 illustrates an exemplary series of events relating to a billboard poster. It is to be understood that although the following relates specifically to posters, it is equally applicable to other outdoor media formats including digital signage.

The group of elements 126 include the events involved in producing raw materials for a poster panel. In particular oil and timber are obtained and transported to production and milling plants. The group of elements 128 are concerned with handling waste from the production and milling plants. In particular, these elements specify that co-products and waste are produced, and the waste is transported to a landfill site for disposal. The group of elements 130 are concerned with producing a poster panel using the raw materials described previously. In particular, the raw materials are transported to a panel production facility wherein the poster panel is produced along with waste which is transported to the landfill site for disposal. The group of elements 132 are concerned with printing the poster onto the poster panel produced previously. In particular, the panel is transported to a printing facility wherein the poster is printed onto the panel using ink. Waste is produced during printing and transported to the landfill site for disposal. Additionally at this stage, CO2 emissions resulting from planning the poster campaign and designing the poster are considered. The group of elements 134 are concerned with transportation of the printed poster along with glue for use in installing the poster to a storage depot. In particular, production and sale of the glue is considered along with the transport of it from its production point to the storage depot. Additionally considered at this stage is the waste from the storage depot along with transport of that waste to a landfill site for disposal. The group of elements 136 consider the use phase of the poster. In particular, these elements consider transport of the poster from the storage depot to its use site, illumination at its use site and the waste generated as a result of that use together with transport of that waste to a landfill site for disposal. Also considered at this stage is the ultimate disposal of the poster and transport of it from the use site to the landfill.

In summary therefore it can be seen that the events considered in FIG. 8 highlight the actions involved in poster production which cause the production of CO2. Accordingly, it is possible to identify sources of CO2 production associated with poster production. The next phase in the method is to identify a specific lifecycle for a poster which defines poster production as a series of stages, wherein each stage causes the production of CO2.

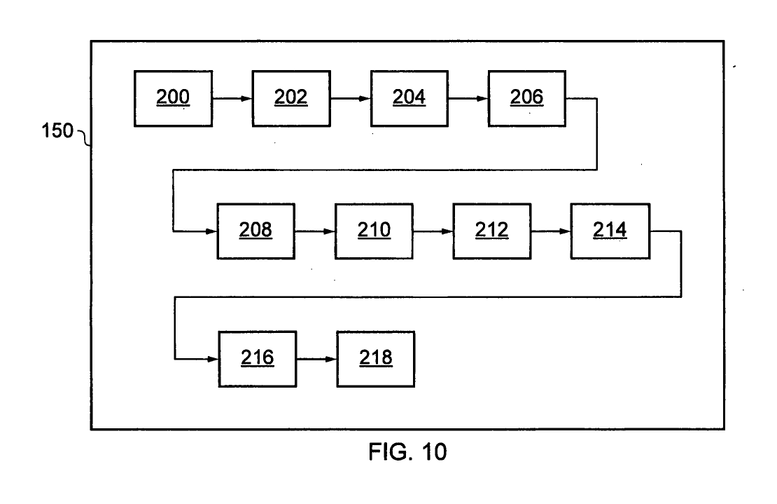

FIG. 10 provides a block diagram of a lifecycle 150 relating to poster production. The lifecycle 150 comprises a series of stages 200 to 218, each of which will now be described in detail. The stage 200 relates to CO2 production resulting from fuel and electricity usage at the offices where planning of the poster takes place. The stage 202 relates to CO2 production resulting from the extraction of raw materials for making the poster panel, processing of those raw materials into a poster panel, and transport of the poster panel to the printing facility. The stage 204 relates to CO2 production resulting from fuel and electricity usage at the printing facility. The stage 206 relates to CO2 production resulting from fuel and electricity usage at the poster design office. The stage 208 relates to CO2 production resulting from transportation of the printed poster to the storage depot. The stage 210 relates to CO2 production resulting from fuel and electricity usage at the storage depot during storage of the poster. The stage 212 relates to CO2 production resulting from transportation of the poster from the storage depot to the use site, and return of the vehicle back to the storage depot. The stage 214 relates to CO2 production resulting from the use phase, including illumination of the poster during use and other electrical services relating to the use phase, such as, for example, electric motor use to rotate a scrolling billboard. The stage 216 relates to CO2 production resulting from transportation of the poster from the use site to a disposal site. The stage 218 relates to CO2 production resulting from disposing of the poster, such as, for example, operating recycling machinery, or operating machinery at a landfill site.

Once the lifecycle 150 has been defined a calculator must be defined for each of stages (200 to 218). As discussed previously, each stage has associated therewith a calculator which receives particular values and performs a mathematical operation on those inputs in order to generate a CO2 emission relating to the stage. Also, each calculator is associated with raw data values which are specific to the lifecycle stage which the calculator is associated with. In particular, the individual raw data elements or values relate to CO2 emission sources originating from the lifecycle of outdoor media format. These CO2 emission sources include, the media buyer or planning office; transfer of content to display medium (digital signage); raw material extraction, processing and transport for paper, plastics, glue and inks used; printing of materials (posters); the design office, transportation from printer to storage depot (poster); storage at media owner and contractor depots; transportation to use site, maintenance, illumination and other electrical services at use site, transportation to disposal, the act of disposal.

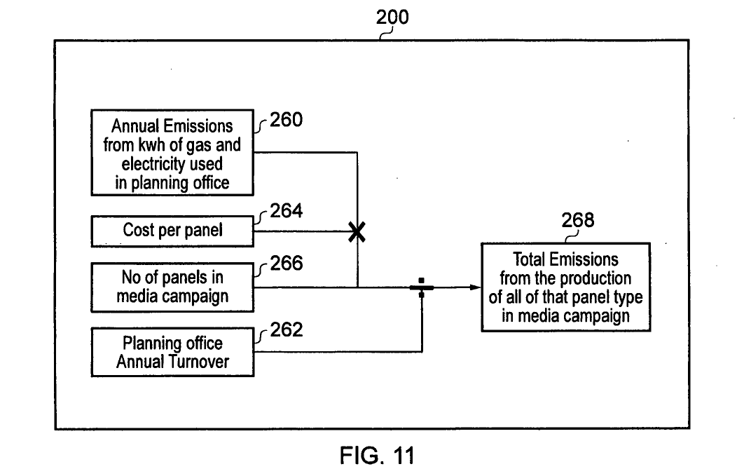

FIGS. 11 to 14 each specify a calculator associated with one of the stages 200 to 218.

FIG. 11 illustrates a calculator associated with stage 200 of FIG. 10, i.e. the planning stage. The calculator of FIG. 11 receives two input values 260 and 262 from the media plan entered by the user, and two raw data values 264 and 266 which are stored on the hard disk 74 of the computer system 50. It is noted that raw data values are represented in the Figures by an unshaded box whereas input values are represented in the Figures by a shaded box. The calculator performs a mathematical function on those four values to produce an output value 268. Specifically, the raw data value 260 is the annual CO2 emissions resulting from each kilo-watt hour of gas and electricity used at the planning offices. The raw data value 262 is the annual turnover of the planning office. The input value 264 is the cost per poster panel and the input value 266 is the number of poster panels in the media plan. According to the calculator of FIG. 11 the values 260, 264 and 266 are multiplied together and the product is divided by value 262 to produce the output 268. The output value 264 is the total amount of CO2 emissions caused by planning the poster panels specified in the media plan, in kgCO2 per unit contribution to turnover.

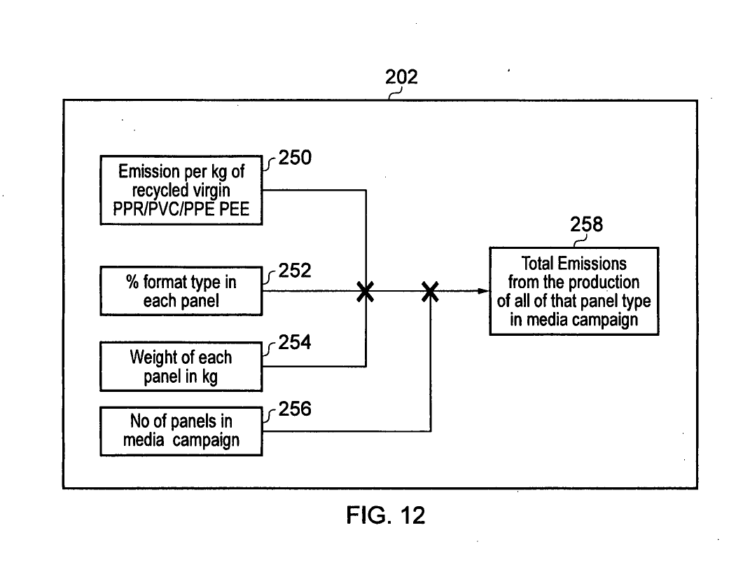

FIG. 12 illustrates a calculator associated with stage 202 of FIG. 10, i.e. poster panel production. The calculator of FIG. 12 multiplies together three raw data values 250 to 254 with one input value 256 in order to produce an output value 258. Specifically, the raw data value 250 is the CO2 emissions generated during the production of one kilogram of recycled virgin PPR/PVC/PPE/PEE material. The raw data value 252 is the percentage of the recycled material in each panel and the raw data value 254 is the weight of each panel in kilograms. The input value 256 is the number of panels specified in the media plan. The output value 258 is the total CO2 emissions caused by the production of the poster panels specified in the media plan, in kgCO2 per poster panel.

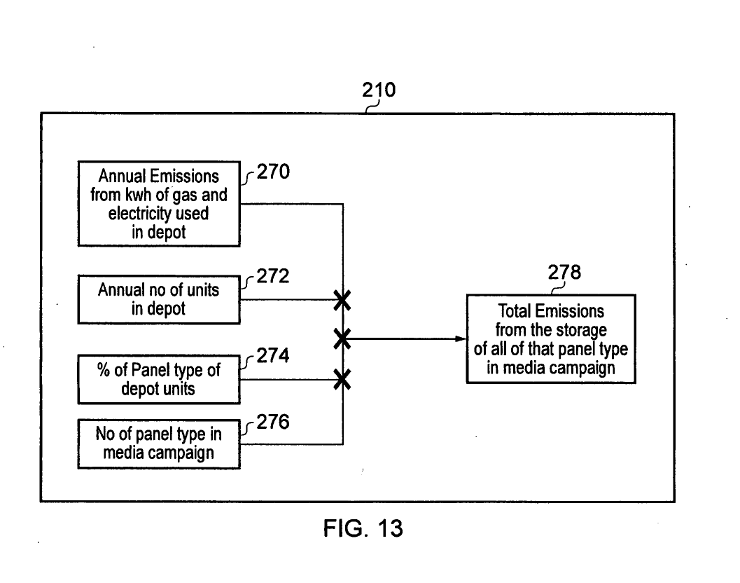

FIG. 13 illustrates a calculator associated with stage 210 of FIG. 10, i.e. the storage phase. The calculator of FIG. 13 receives three raw data values 270 to 274, one input value 276 and produces an output value 278. Specifically, value 270 is the annual CO2 emissions from the usage of one kilowatt hour of gas and electricity in the storage depot. The value 272 is the annual number of stored units in the depot. The value 274 is the percentage of stored units which are made up of the poster panels. The input value 276 is the number of poster panels in the media plan. According to the calculator of FIG. 12, the three raw data values 270 to 274 are multiplied together with the input data value 276 to produce the output 278. The output 278 is the total CO2 emissions from the storage of all the poster panels specified in the media plan, in kgCO2 per poster panel.

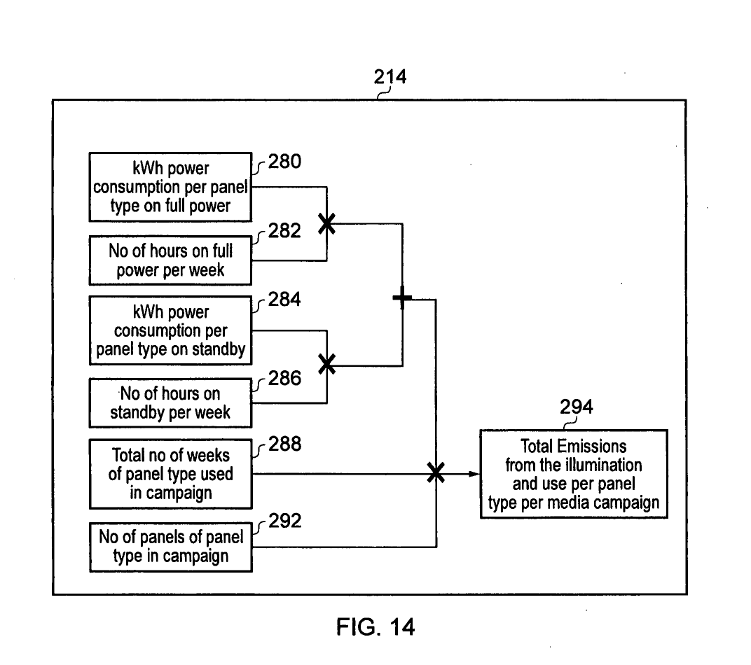

FIG. 14 illustrates a calculator associated with stage 214 of FIG. 10, i.e. the use phase. The calculator of FIG. 14 receives four raw data values 280 to 286, two input values 288 and 290, and produces output value 292. The raw data value 280 is the kilowatt hour power consumption for use on full power per poster. The raw data value 282 is the number of hours the billboard is on full power per week. The raw data value 284 is the kilowatt hour power consumption for use on standby power per poster. The raw data value 286 is the number of hours the billboard is on standby power per week. The input value 288 is the total number of weeks the poster is used in the media plan. The input value 290 is the number of posters in the media plan. In operation, the calculator of FIG. 13 multiplies together raw data values 280 and 282, and separately multiplies together raw data values 284 and 286. The two products generated are summed together to create a further value which is multiplied with input values 288 and 290 to produce the output value 292. The output value 292 is the total CO2 emissions caused by the illumination and use of the poster panels specified in the media plan, in kgCO2 per poster used per week.

It is to be understood that in the present example embodiment, although not shown, corresponding calculators and raw data values are defined in lifecycle 150 for stages 204, 206, 208, 212, 216 and 218.

In view of the above, the computer system 50 according to the present example embodiment can load into memory the lifecycle 150. The computer system 50 can then use the calculators associated with the lifecycle 150 to calculate CO2 emissions values relating to each stage (200 to 218) of the lifecycle 150. In practise, the media plan may contain a plurality of different outdoor media format types. Therefore, the computer system 50 begins by operating on the poster type first listed in the media plan and then works through any remaining poster types in sequence. Considering the poster type listed first, for each stage (200 to 218) in the lifecycle 150, the CPU 52 generates a CO2 emission value specific to that stage. Once a CO2 value has been calculated for each stage in the lifecycle 150, the values can be stored in memory. The computer system 50 can then repeat this process to generate corresponding CO2 values for each other different poster type mentioned in the media plan. It is to be understood that although this example embodiment works though the poster types in the order that they are included in the media plan, other sequences are equally valid. For example, in other embodiments the sequence could be in the reverse order listed.

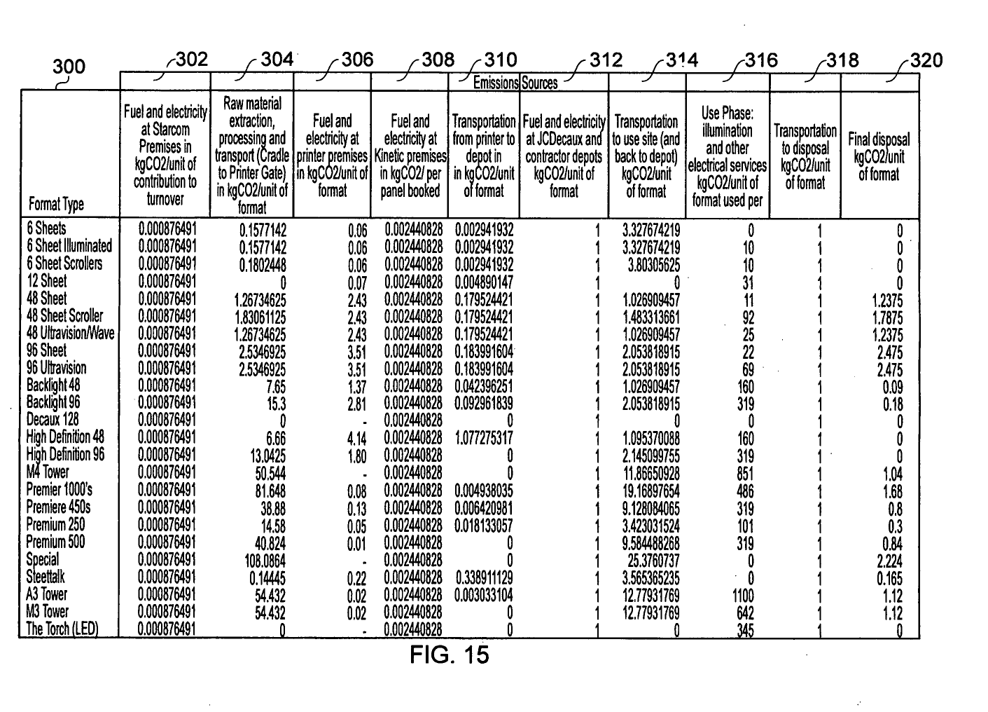

FIG. 15 illustrates in tabular form the result of the above process, i.e. once a CO2 value has been calculated for the complete lifecycle in respect of each different poster type, and the CO2 values have been stored in memory. FIG. 15 comprises a number of columns (300 to 320) and rows. The column 300 identifies all the different billboard poster types specified in the media plan; each different billboard poster type is positioned a separate row. The columns 302 to 320 correspond with the stages 200 to 218 of the lifecycle 150. Therefore, each row of FIG. 15 provides all the CO2 emission values relating to one particular poster type specified in the media plan. All the rows together provide all the CO2 emissions values for all the posters specified in the media plan. Since the media plan only consists of different poster types, FIG. 15 includes all the CO2 emissions values relating to the complete media plan.

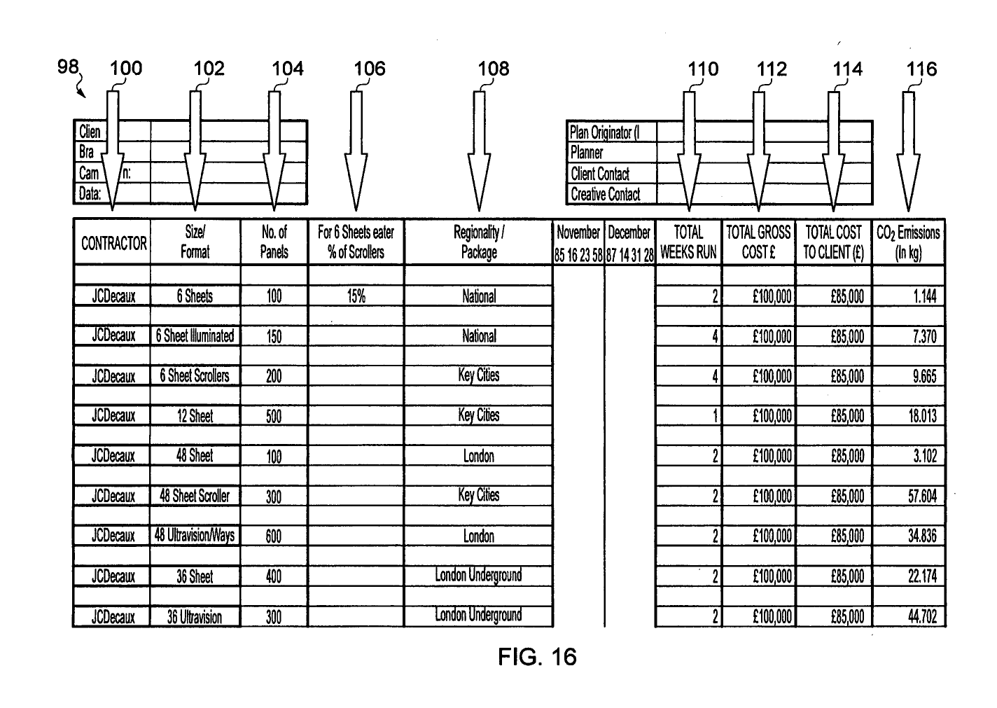

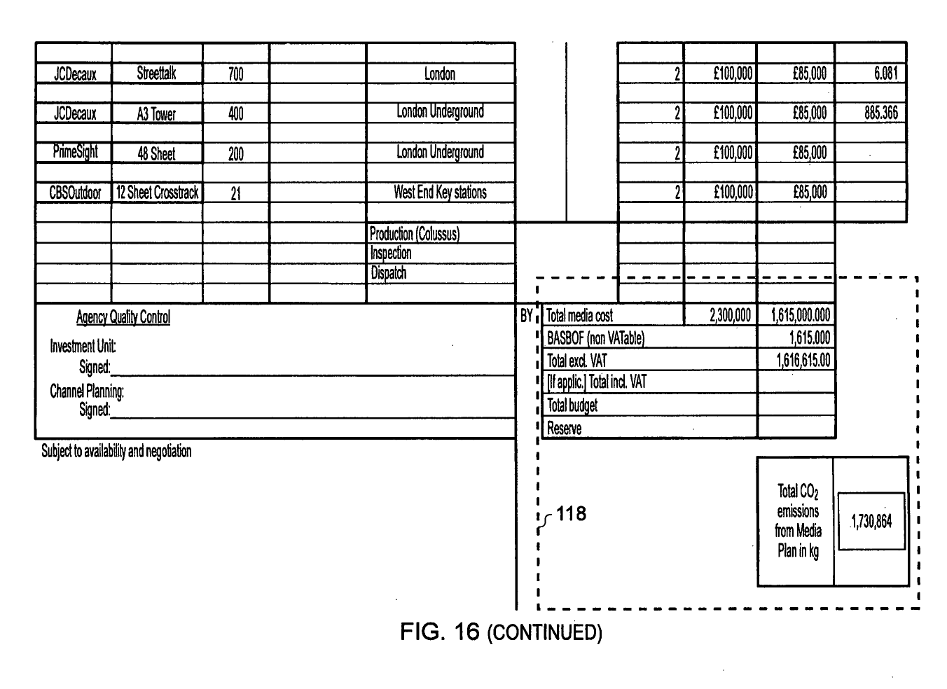

FIG. 16 is another view of the user interface 98. However, in FIG. 16 the values discussed previously with reference to FIG. 15 have been used to generate CO2 emission values which are displayed on the user interface 98. Specifically, the column 116 has been populated with CO2 emissions values for each poster type specified in the media plan. These values are generated by summing all the values in a single row of FIG. 15. Additionally, the region 118 has been populated with a total CO2 emissions value for the entire media plan. This value is generated by summing all the CO2 emission values in column 116, or stated differently, by summing all the CO2 emission values in FIG. 15.

According to the above described operation of the computer system according to the present example embodiment, the user inputs a media plan to the user interface displayed by the computer system. The computer system then loads a lifecycle corresponding to the media types specified in the media plan and calculates CO2 emission values for each different media type in the media plan. The computer system then displays the CO2 emission values to the user via the user interface. The user is therefore able to easily identify the quantity of CO2 which is likely to be produced by implementing the proposed media plan. The user can also identify how much CO2 is attributed to each different media format type. Accordingly, the user can use the embodiment to adjust the media plan to fall below a CO2 threshold or benchmark. The user can also identify the carbon foot print of the media plan, and the individual components of the media plan.

It is to be understood that the computer system according to the present example embodiment may generate different CO2 emissions values relating to the different media formats specified in the media plan. For example, the computer system may additionally generate a value for the kilograms of CO2 emitted per person reached by each outdoor advertising media format. Also, additional or alternative input values may also be provided by the user in the media plan, such as, for example, a frequency that the poster or digital poster is displayed on a scrolling billboard or digital sign.

It is to be understood that the calculators of the present example embodiment rely on input values. These input values are provided in two ways, either as part of a media plan by a user, or as stored raw data values on the computer system. The formation of raw data values can be performed in a variety of different ways. The following describes the approach used in the present example embodiment.

Principally, the raw data values are collected empirically. It is necessary to collect raw data values to assist in the calculation of CO2 values for each stage in the lifecycle 150. As stated above, the present example embodiment is limited to the outdoor media format, although a variety of different types can be specified. The collection of raw data values relating to each stage in the lifecycle 150 will now be considered in turn.

Considering stage 200, i.e. the planning stage, the annual electricity and oil consumption at the planning office was identified. The CO2 emissions relating to the annual electricity and oil consumption were then calculated to produce a value for the number of kilograms of CO2 produced annually at the planning office. The annual CO2 consumption was then divided by the annual turnover of the planning office to yield a value for the total CO2 emissions per unit of turnover.

Considering stage 202, i.e. the panel production stage, the CO2 emissions relating to the extraction and production of various raw materials were determined. CO2 emissions relating to the raw materials in both recycled and non-recycled form were determined. The raw materials included paper, PVC, polypropylene and high and low density polyethylene. Accordingly, a CO2 emission value was determined for each poster panel composition. The value depended on which raw materials were used and what percentage of the panel was made of recycled material.

Considering stage 204, i.e. the printing stage, details of annual gas and electricity consumption at the different printing facilities were obtained. This consumption was converted to an annual amount of CO2 produced by respective printing facilities. Next, the annual square meters of printing performed at the printing facilities was determined. This figure was combined with the previous figure to yield the kilograms of CO2 produced per square meter of printing at different facilities. Next was considered how much ink was used in the printing process, and therefore, how much CO2 was attributed per panel to ink. All of these figures were then combined to produce an amount of CO2 produced by printing one metre squared of panel at each different facility. This value was then scaled according to panel size.

Considering stage 206, i.e. the design stage, details of the annual energy consumption by the design office were obtained and converted into an amount of annual CO2 generation. This figure was then scaled by the percentage of the design office which handle poster design.

This figure was then scaled by the number of posters designed. The end result therefore provides a CO2 amount in kilograms used by the design office per poster designed.

Considering stage 208, i.e. the transport to storage stage, the distance from the printing facility to the storage facility was identified. This figure was then converted into an annual amount of distance travelled, which in turn was converted into an amount of CO2 produced per delivery. Given the amount of printed material delivered annually, is it possible to calculate the total CO2 emissions per square meter of printed material in kg of CO2. This value can then be scaled to yield a value for the average emissions of CO2 in kg per poster delivered.

Considering stage 210, i.e. the storage stage, the annual gas and electricity consumption of the storage facility was determined along with the number of posters passing through the facility in a year. The annual gas and electricity consumption was converted into a CO2 production value to yield an amount of CO2 produced per panel stored. This value was then scaled according to the size of the panel.

Considering stage 212, i.e. the transport to use stage, the CO2 emission during this stage was calculated in a corresponding way to stage 208 to yield a value of the total CO2 produced transporting particular panels to the use site. However, this stage also considered the return journey from the use site back to the storage facility.

Considering stage 214, i.e. the use stage, the electricity usage of the billboard to display the poster was identified. In particular, electricity usage may come from illumination alone or other additional sources, including motors for scrolling posters. Additionally, the rate of electricity use changes depending on whether illumination occurs only at night or throughout the whole day. Furthermore, electricity usage changes depending on whether or not the billboard enters a standby mode for a portion of the time. In any case, the relevant factors were considered and an appropriate amount of electricity usage was identified for each different situation. These figures were then converted into an amount of CO2 generated per poster per week.

Considering stage 216, i.e. the transport to disposal stage, the CO2 emission during this stage was calculated in a corresponding way to stages 212 and 208 to yield a value of the total CO2 produced transporting particular panels to the disposal site.

Considering stage 218, i.e. the disposal stage, the weight of the poster was determined in kg. Also, the percentage of the poster which can be recycled was identified to establish what proportion of the total weight ends up in a landfill. Then, the emissions relating to the proportion being dumped in a landfill is converted into an amount of CO2 produced.

It is to be understood that although the raw data values were obtained using that above considerations in the present example embodiment, in some other embodiments different considerations may be taken into account, or raw data values may be calculated in different ways. In any case, it is necessary to collect raw data values which enable the derivation of an amount of CO2 emitted per media format unit per lifecycle stage.

As mentioned above, the present example embodiment is directed towards a media plan for outdoor media formats. However, the present invention is equally applicable to other media formats. Next will be considered how the principle of the present invention can be applied to media formats other than outdoor media formats.

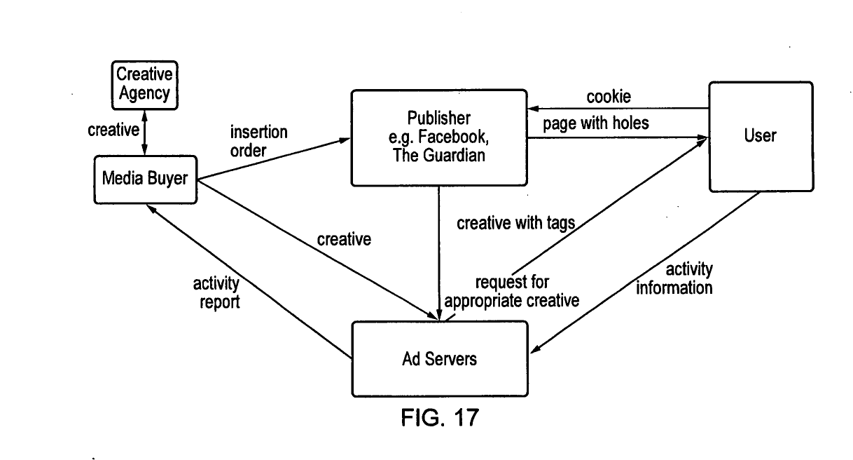

FIG. 17 illustrates an exemplary series of events relating to digital display media. Digital display media refers to advertising on websites that takes the form of an image and may incorporate expanding elements and video. The additional information required from the user in the media plan may include any of the following: the position of the digital display media on the page; the size of the digital display media in pixels (if interactive then the pixel size during interaction), the size of the digital display media in kilobytes (if requiring buffering then the kilobytes during buffering); the number of impressions; the number of impressions per publisher; if interactive then the number of interactions; if interactive then duration of interaction; duration the page is top window; number of click throughs; breakdown of impressions per browser. The raw data values required may include any of the following: media buyer (planning) office emissions; Adserver office emissions; Adserver server and router emissions; generic internet data transmission emissions; display device emissions. The CO2 emission values produced may include any of the following: the gCO2 per average impression, and the kgCO2 per campaign. Different digital display media can have different features which impact on how much CO2 is produced by them during an advertising campaign. Some exemplary considerations are as follows. The different types can be classified in terms of their function and form. The function can be for branding, awareness or acquisition, whereas the form can be either static or interactive. They typically come in five standard pixel sizes including banners, and MPU's (web banners), however, any size is possible. Further, there is no limit to the size of the file which drives the advertising. The cost can vary according to the number of insertions, the size, the position, the circulation, availability, colour, content, target audience, weight and capacity of the advert. The effectiveness can be identified by data fed back from Ad servers, reach and frequency, cost per conversion (e.g. click) and dwell time.

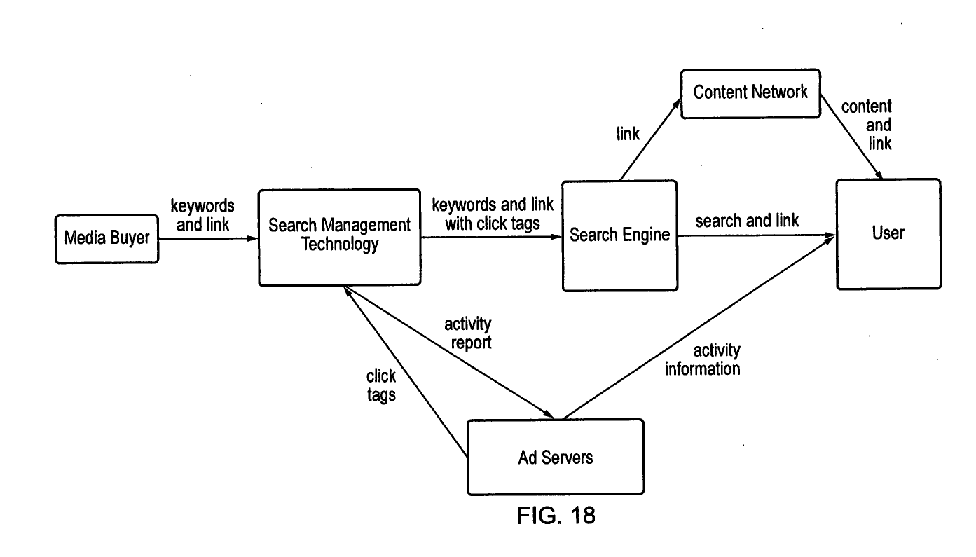

FIG. 18 illustrates an exemplary series of events relating to paid search media. Paid search media refers to advertising through plain text webpage links, sometimes referred to as “sponsored links”, shown in webpages of search results (generated by a search engine or comparative shopping site) that appear when certain keywords are searched for. They usually appear at the top of the list of results in a box of a different colour to the rest of the page or to the right of the page in a separate column. The additional information required from the user when they specify the media plan may include any of the following: the type of link; the number of impressions, the number of impressions per search engine; the number of click throughs; the breakdown of impressions per browser. The raw data values required may include any of the following: media buyer (planning) office emissions; Adserver office emissions; Adserver server and router emissions; search engine office emissions; search engine server and router emissions; generic internet data transmission emissions; display device emissions. The CO2 emission values produced may include any of the following: the gCO2 emitted per average impression, and the kgCO2 emitted per campaign. Different paid search media formats can have different features which impact on how much CO2 is produced by them during an advertising campaign. Some exemplary considerations are as follows. The different types can be classified in terms of their function and form. The function can be for branding, awareness or acquisition, whereas the form can be either static or interactive. They typically come in five standard pixel sizes including banners, and MPU's (web banners), however, any size is possible. Further, there is no limit to the size of the file which drives the advertising. The cost can vary according to the number of insertions, the size, the position, the circulation, availability, colour, content, target audience, weight and capacity of the advert. The effectiveness can be identified by data fed back from Ad servers, reach and frequency, cost per conversion (e.g. click) and dwell time.

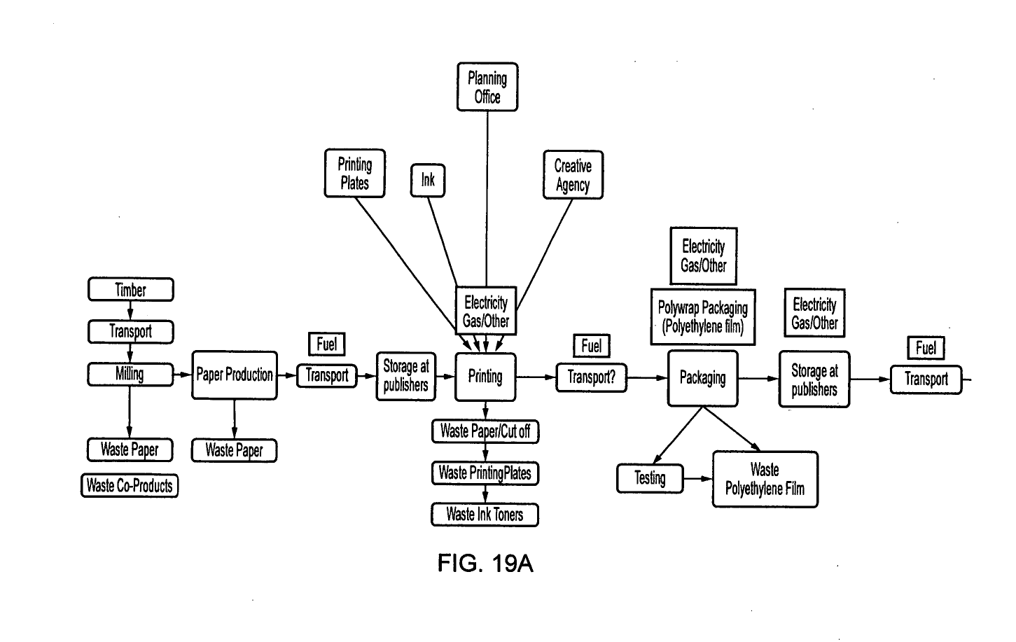

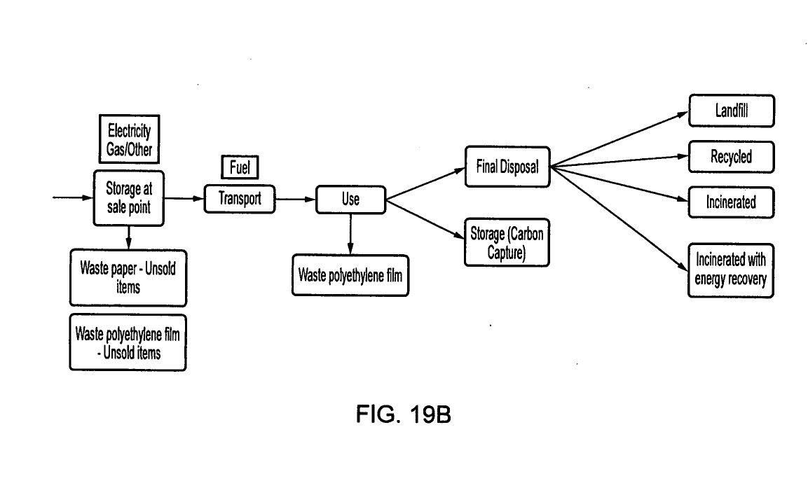

FIGS. 19a and 19b illustrate an exemplary series of events relating to press advertising. The press media format is described as all advertising in regional and national newspapers and trade and consumer magazines. The additional information required from the user in the media plan may include any of the following: for newspapers, whether the newspaper is national or regional, the advert format type, the number of single column centres, the number of inserts, the number of publications, the number of newspapers, which specific newspaper, the position in the newspaper, the newspaper area, the number of pages in the newspaper. For magazines, whether it is a consumer or trade magazine, the advert format type, the advert format size, the number of publications, the number of magazines, the position in the magazine, the magazine size, the number of pages in the magazine. The raw data values required may include any of the following: the media buyer (planning) office emissions; emissions from the raw material extraction processing and transport for paper, inks, chemicals; emissions from the storage of produced paper; emissions from the transportation to printers; emissions from fuel and electricity usage at the printer premises; emissions from the storage of printed newspapers or magazines; emissions from the distribution of printed newspaper and magazines; emissions from the storage at retail outlets of newspaper and magazines; emissions from transportation to disposal; emissions from final disposal. The CO2 emission values produced may include any of the following: the kgCO2 emitted per advertisement printed, the kg of CO2 per advertisement sent, the kg of CO2 per campaign, the kg of CO2 per person reached. Different press adverts can have different features which impact on how much CO2 is produced by them during an advertising campaign. Some exemplary considerations are as follows. The press advert can have different purposes, for example, it can be for display, advertorial, sponsorship, bound in, special, content or tip on. The press advert can have different sizes, for example, it can be a newspaper advert to cover a single column. Alternatively, it can be a magazine advert which covers a full page, fractions of a page or a double page spread. The press advert can vary a number of other respects including, publication, number of insertions, size, position, circulation, availability, colour, content, target audience, weight and capacity (relating to packaging). The effectiveness of the press advert can identified using a number of factors including, target group, reach and frequency, national readership survey (NRS), TGI (further in-depth analysis than NRS), and audited bureau of circulation (ABC). The press advert can also vary in distribution in terms of whether it is available at supermarkets, newsagents, news stands, mail order. Also whether or not the advert is distributed in a controlled fashion or an uncontrolled fashion affects distribution.

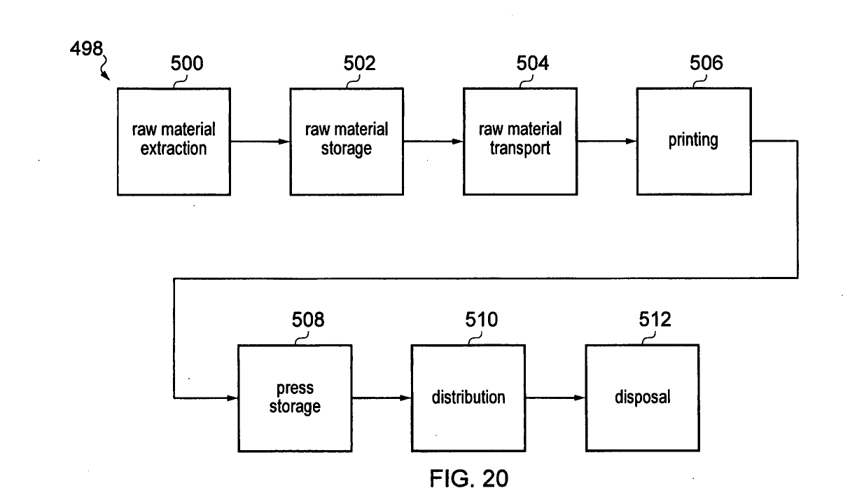

FIG. 20 shows an exemplary lifecycle 498 relating to an advert for an item of press media format, such as, for example, a newspaper or a magazine. Each phase or block of the lifecycle 498 corresponds to a phase or stage in the life of the press advert which causes CO2 to be generated as a by-product. Specifically, block 500 represents a raw material extraction phase in which raw materials are obtained for creating a medium for carrying the advert. For example, this phase may account for CO2 production caused by felling trees in order to create timber for use in creating paper on which the advert is to be printed. Additionally, this phase may account for CO2 production caused by milling of the timber, and the transportation of the paper to a storage facility. This phase may also include the CO2 emitted in the creation and transportation of raw materials relating to production of the advert, such as, for example, chemicals used in manufacturing ink for printing the advert.

Block 502 represents a raw material storage phase in which the raw materials produced in step 500 are stored pending their use in producing the advert. Block 504 represents a raw material transportation phase in which the raw materials produced in block 500, and stored in block 502, are transported to a printing facility. Block 506 represents a printing phase in which the raw materials of the previous blocks are combined to create the advert in a press media item. This phase may account for CO2 production in creating and using printing machinery, such as, printing plates. Also, this phase may account for CO2 production relating to planning the advert together with CO2 emissions associated with designing the advert. For example, this stage may account for the power and heating used by the planning office and the creative design office in planning and designing the advert. Further, this stage may account for the CO2 emissions relating to wastage at the printing facility. For example, wastage may include paper wastage (i.e. paper cut-offs), waste printing plates and waste ink toners. Furthermore, the printing stage may account for CO2 production caused by design, planning and creation of packaging for the advert. For example, the planning phase may include the CO2 emitted relating to powering and heating the packaging planning and design offices, the CO2 emitted in creating the packaging, the CO2 emitted in testing the packaging, and the CO2 emitted relating to waste products of packaging development.

Block 508 represents a storage phase relating to the printed advert. Specifically, this storage phase may represent the CO2 emissions relating to powering and heating the storage facility while the advert is stored therein. Block 510 represents a distribution phase when the advert is taken from the storage facility and ultimately delivered to an end user. This phase may include the CO2 emitted as a result of transporting the advert, the storage at one or more sale points, and wastage in the form of adverts in unsold press media items and a portion of waste packaging. Additionally, this phase may also represent the CO2 emissions relating to use of the press media item with the advert up until its final disposal. Block 512 represents a disposal phase in which the advert is disposed of. Specifically, the disposal phase may include CO2 emissions in storing a disposed-of advert. Also, this phase may account for CO2 emissions associated with the actual disposal of the advert, for example, at a landfill, a recycling plant, or an incinerator plant with or without energy recovery.

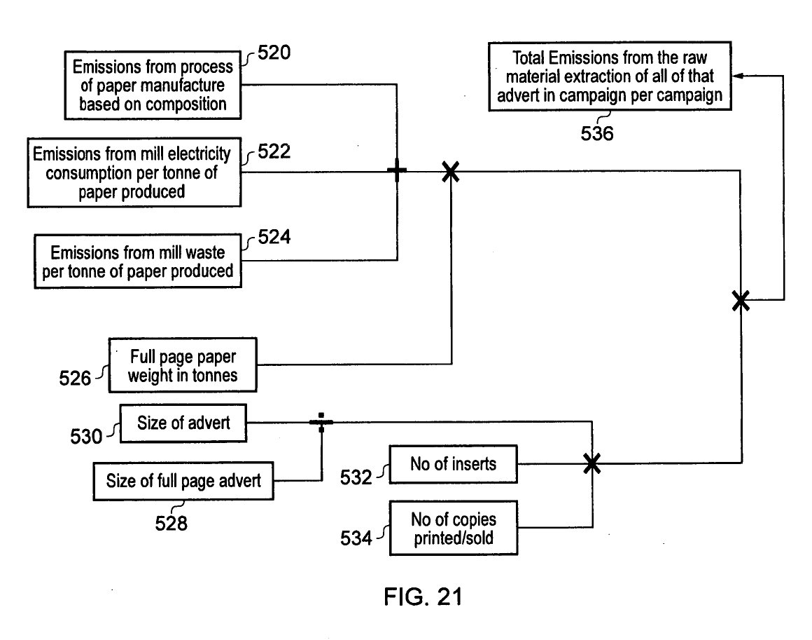

In view of the above, the flow diagram of FIG. 20 represents each stage in the life of an advert for a press media item. Specifically, the lifecycle 498 of FIG. 20 is arranged such that CO2 emissions associated with each stage in the life of the advert are accounted for. As before, one instance of the lifecycle 498 relates to a specific type of press advert specified in the media plan. Each different type of press item in the media plan will require a separate instance of lifecycle 498. In order to determine specific values of CO2 production associated with each stage in the lifecycle 498, a series of calculators are generated, in an analogous way to as described above with respect to the outdoor media format embodiment. FIGS. 21 to 31 represent exemplary calculators for use in calculating CO2 emissions associated with particular phases (500 to 512) in the lifecycle 498 of a specific type of press advert. Each of the calculators operate in a corresponding way to the above-described calculators associated with the outdoor media format embodiment. The following describes the calculators of FIGS. 21 to 31 in more detail.

FIG. 21 illustrates a calculator associated with block 500 of FIG. 20, i.e. the raw material extraction phase. The calculator of FIG. 21 receives five raw data values 520 to 528, three input values 530 to 534, and produces output value 536. The raw data value 520 is the CO2 emissions associated with the manufacture of paper used in the press media item containing the advert. Since these emissions are dependent on the precise composition of the paper, this value changes in dependence on paper composition. The raw data value 522 is the CO2 emissions associated with the electricity composition of the mill used to create the paper. This value is normalised in order to generate a value for CO2 emissions per ton of paper produced. The raw data value 524 is the CO2 emissions from the paper mill associated with waste per ton of paper produced. The raw data value 526 is the full page paper weight measured in tons. The raw data 528 is the size of a full page advert. The input value 530 is the actual size of the advert. The input value 532 is the number of inserts i.e. the number of times the advert is inserted into a page in the publication. The input value 534 is the number of copies of the press media item containing the advert which are printed or sold, i.e. the number of adverts which are printed or sold. The output value 536 generated by the calculator is the total CO2 emissions from raw material extraction relating to the advert as specified in the media plan. In operation, the calculator of FIG. 20 sums together raw data values 520 to 524 and multiplies the result by raw data value 526. Separately, the calculator divides input value 530 by raw data value 528, and multiplies the result by input values 532 and 534. The two resultant values generated by these operations are then multiplied together to create the output value 536.

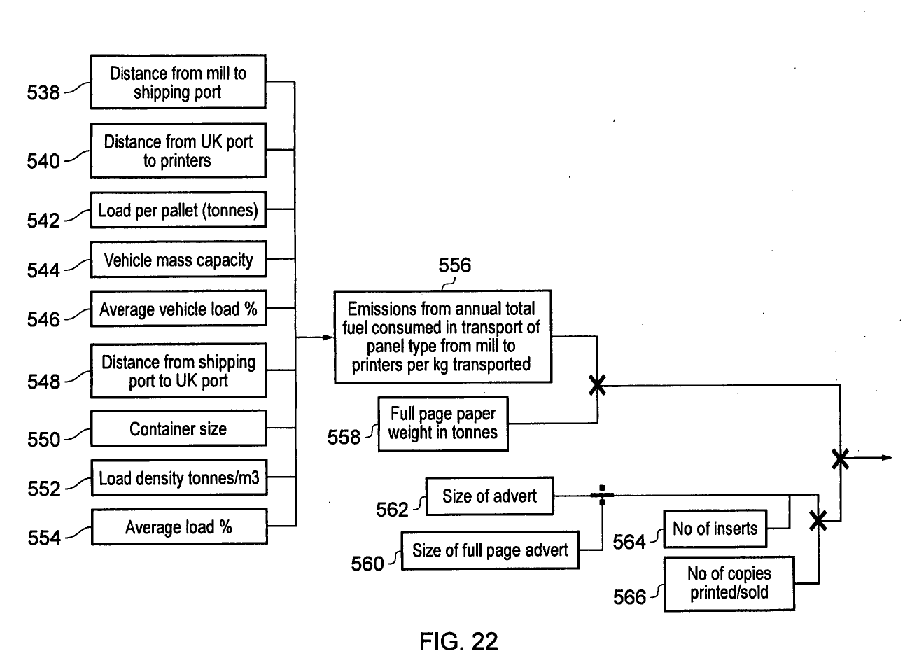

FIG. 22 illustrates a calculator associated with the stage 504 of FIG. 20, i.e. the raw material transport phase. Specifically, this calculator relates to CO2 emissions relating to transporting paper from the paper mill to the printing facility. The calculator of FIG. 22 operates on twelve raw data values 538 to 560, three input values 562 to 566 and generates one output value. As seen more particularly in FIG. 22, raw data values 538 to 554 are combined together to generate a further raw data value 556. Raw data value 556 is the CO2 emissions associated with the annual total fuel consumed in transporting a kilogram of paper from the paper mill to the printers. The value 556 is generated using the following raw data values: the distance from the paper mill to the shipping port (538), the distance from the destination port to the printers (540), the weight in tons of a palate of paper (542), the mass capacity of the transportation vehicle (544), the average vehicle load percentage (546), the distance from the shipping port to the destination port (548), the shipping container size (550), the load density of the shipping container in tons per cubic metre (552), and the average load utilisation percentage (554). The raw data value 558 is the full page paper weight in tons. The raw data value 560 is the size of a full page advert. The input value 562 is the size of the advert. The input value 564 is the number of inserts. The input value 566 is the number of copies of the press media item containing the advert which are printed or sold. In operation, the calculator of FIG. 22 uses raw data values 538 to 554 to generate raw data value 556. Raw data value 556 is multiplied by raw data value 558 to generate a first resultant value. Separately, input value 562 is divided by raw data value 560, and the result is multiplied by input values 564 and 566, to generate a second resultant value. The first and second resultant values are then multiplied together to generate an output value which relates to the CO2 emissions associated with transporting paper associated with the advert from the paper mill to a printing facility.

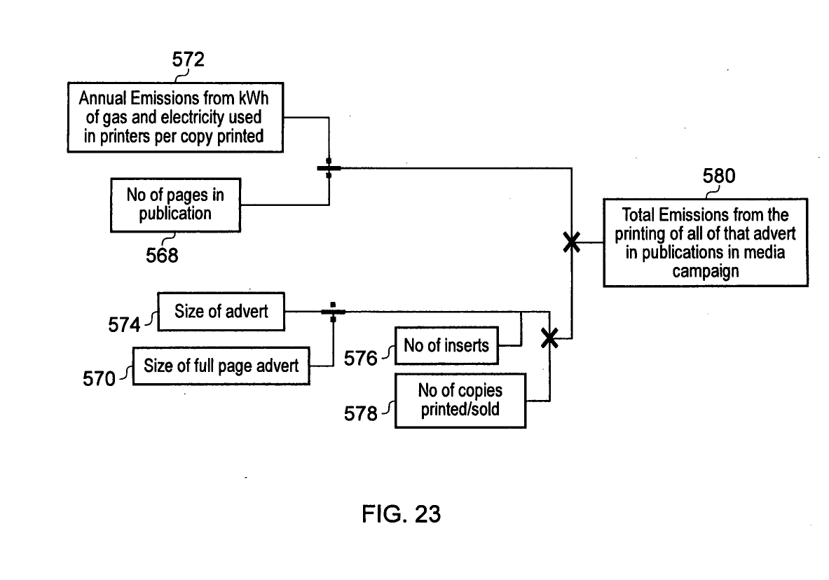

FIG. 23 illustrates a calculator associated with block 506 of FIG. 20, i.e. the printing phase. Specifically, this calculator is associated with CO2 production caused by printing the advert. The calculator of FIG. 23 receives two raw data values 568 and 570, four input values 572 to 578, and produces output value 580. The raw data value 568 is the number of pages in the publication, i.e. the press media item containing the advert. The raw data value 570 is the size of a full page advert in the press media item. The input value 572 is the annual CO2 emissions relating to gas and electricity usage at the printing facility per press media item. The input value 574 is the size of the advert in question. The input value 576 is the number of inserts. The input value 578 is the number of copies of the press media item carrying the advert which are printed or sold. In operation, input value 574 is divided by raw data value 570, and the result is multiplied by input values 576 and 578. Separately, input value 572 is divided by raw data value 568. The two values resulting from the above operations are multiplied together to generate output 580. The output value 580 corresponds to the total CO2 emissions associated with printing the advert according to the media plan.

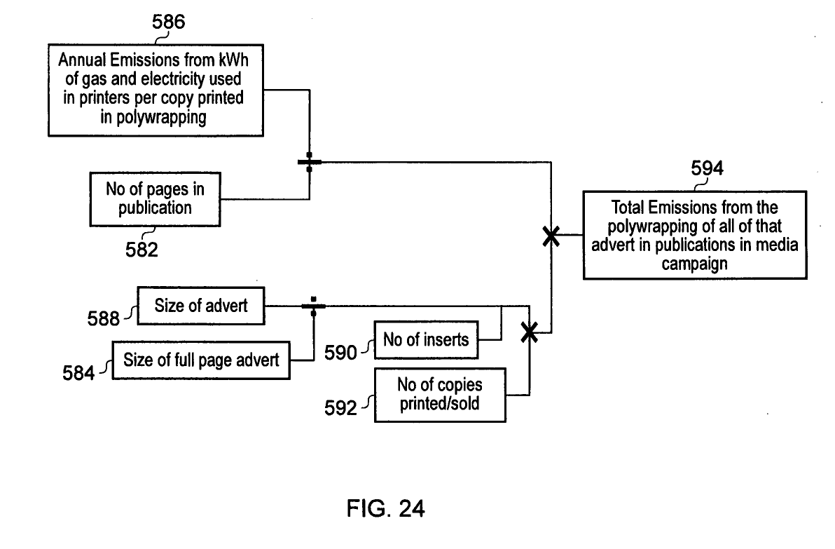

FIG. 24 illustrates a calculator also associated with stage 506 of FIG. 20, i.e. the printing phase. Specifically, this calculator is associated with CO2 production caused by packaging the advert. The calculator of FIG. 24 receives two raw data values 582 and 584, four input values 586 to 592, and produces output value 594. The raw data value 582 is the number of pages in the publication, i.e. the press media item containing the advert. The raw data value 584 is the size of a full page advert. The input value 586 is the CO2 emissions from gas and electricity usage in the printing facility associated with wrapping one copy of the press media item in polywrapping. The input value 588 is the size of the advert in question. The input value 590 is the number of inserts. The input value 592 is the number of copies of the press media item containing the advert in question which are printed or sold. The output value relates to the total CO2 emissions from polywrapping the adverts specified in the media plan. In operation, the input value 588 is divided by the raw data value 504, and the result is multiplied by the input values 590 and 592. Separately, the input value 586 is divided by the raw data value 582. The two values resulting from the above operation are then multiplied together to generate the output value 594.

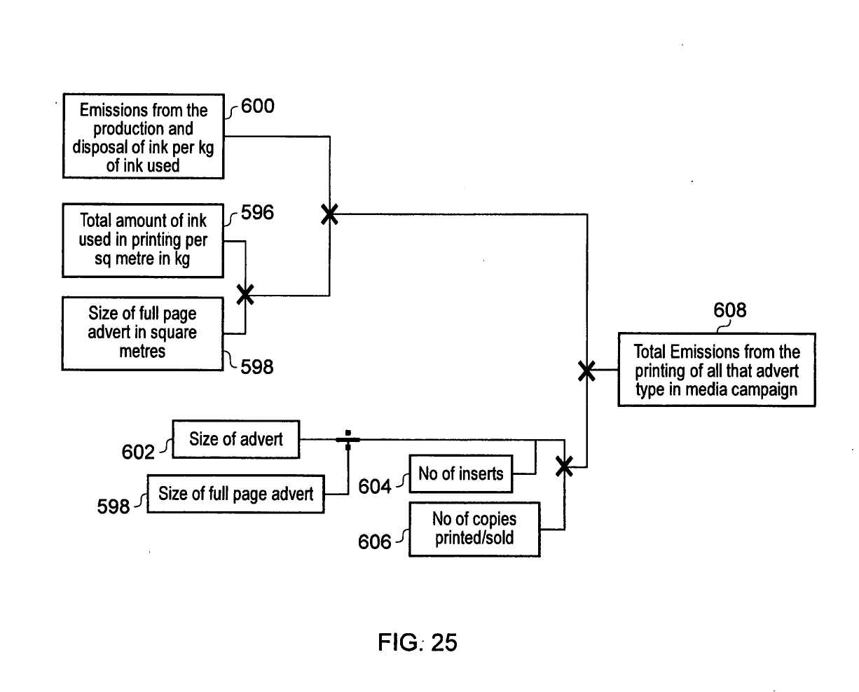

FIG. 25 illustrates a calculator also associated with block 506, i.e. the printing stage. Specifically, this calculator relates to the CO2 produced by the printing facility in the production, use, and disposal of printing semi products, i.e. a product created for and used in the printing process. The calculator of FIG. 25 receives three raw data values 596 and 598, four input values 600 to 606, and produces output value 608. The raw data value 596 is the total weight of ink used in printing one square metre of paper. The raw data value 598 is the size of a full page advert. The input value 600 is the CO2 emissions from production and disposal of ink per kilogram of ink used. The input value 602 is the size of the advert in question. The input 604 is the number of inserts. The input value 606 is the number of copies of the press media item containing the advert which are printed or sold. The output value 608 is the total CO2 emissions from the production, use, and disposal of printing semi-products as a result of printing the advert as specified in the media plan. In operation, input value 602 is divided by raw data value 598, and the result is multiplied by input values 604 and 606. Separately, raw data values 596 and 598 and input value 600 are multiplied together. The two values resulting from the above operation are multiplied together to generate output value 608.

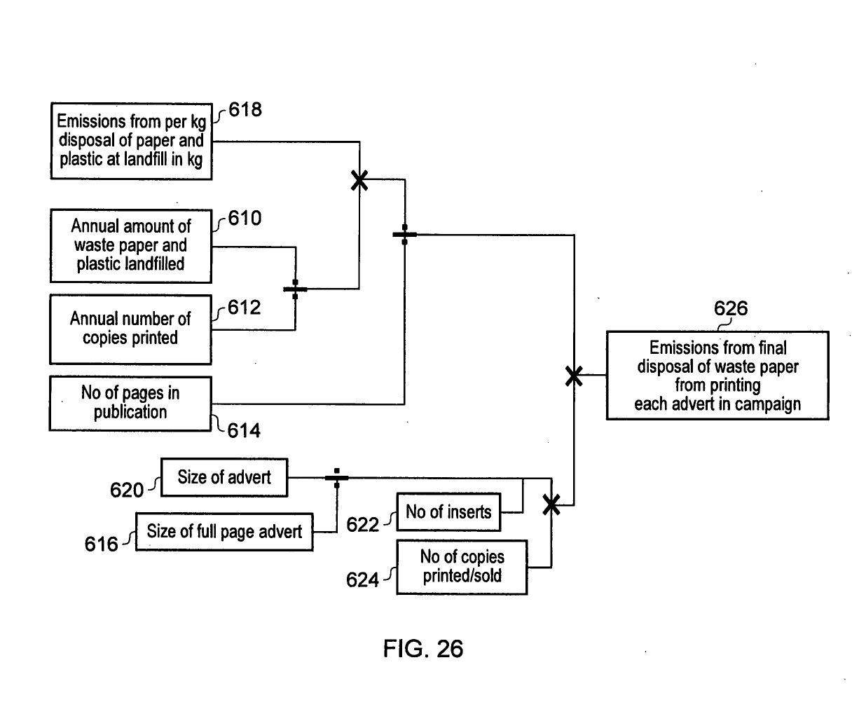

FIG. 26 illustrates a calculator also associated with block 506 of FIG. 20, i.e. the printing phase. The calculator of FIG. 26 relates to CO2 emissions associated with waste paper and plastics generated during the printing process. The calculator of FIG. 26 receives four raw data values 610 to 616, four input values 628 to 624, and produces output value 626. The raw data value 610 is the annual amount of waste paper and plastic land-filled as a result of the printing process. The raw data value 612 is the annual number of printed copies of the press media item containing the advert. The raw data value 614 is the number of pages in the press media item. The raw data value 616 is the size of a full page advert in the press media item. The input value 618 is the CO2 emissions caused by disposal of one kilogram of paper and plastic at a landfill site. The input value 620 is the size of the advert in question. The input value 622 is the number of inserts. The input value 624 is the number of copies of the press media item containing the advert which are printed or sold. The output value 626 is the CO2 emissions resulting from disposal of waste paper generated during the printing phase for each of the adverts produced according to the media plan. In operation, the input value 620 is divided by the raw data value 616, and the result is multiplied by input values 622 and 624. Separately, raw data value 610 is divided by raw data value 612, the result is then multiplied by input value 618, the result of which is then divided by raw data value 614. The two values resulting from the above operation are then multiplied together to generate output value 626.

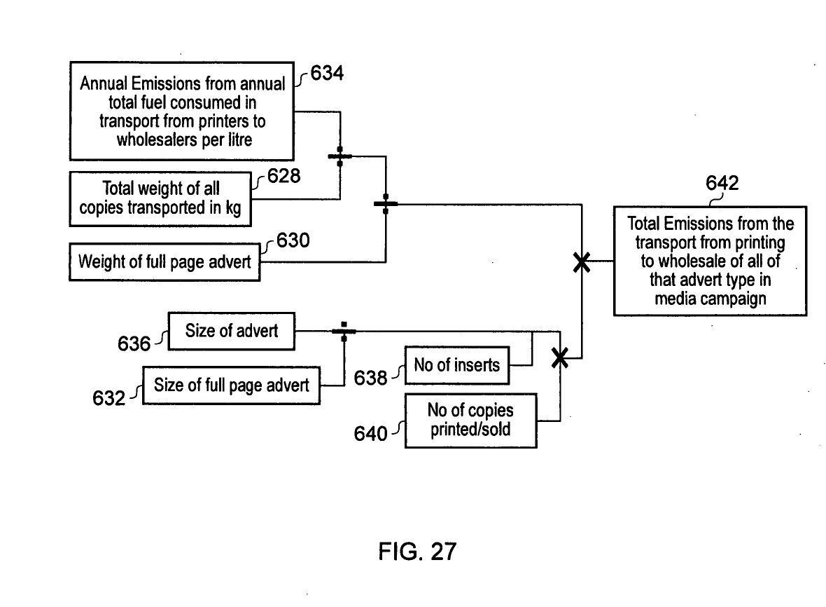

FIG. 27 illustrates a calculator also associated with block 510 of FIG. 20, i.e. the distribution phase. Specifically, the calculator of FIG. 27 relates to CO2 production caused by transportation of press media items from the printing facility to a wholesaler. Further, the calculator of FIG. 27 is used when the annual fuel consumption for this transportation is known. The calculator of FIG. 27 receives three raw data values 628 to 632, four input values 634 to 640 and produces an output value 642. The raw data value 628 is the total weight of all copies of the press media item which are transported. The raw data value 630 is the weight of one full page advert. The raw data value 632 is the size of a full page advert. The input value 634 is the annual CO2 emissions caused by consumption of fuel in transportation from the printing facility to the wholesalers. The input value 636 is the size of the advert in question. The input value 638 is the number of inserts. The input value 640 is the number of copies of the press media item containing the advert which are printed or sold. The output value 642 is the total CO2 emissions caused by transporting all of the adverts listed in the media plan from the printing facility to a wholesale outlet. In operation, the input value 636 is divided by the raw data value 632, the result is then multiplied by the input values 368 and 340. Separately, the input value 624 is divided by the raw data value 628, and the result is then divided by the raw data value 630. The two values resulting from the above operation are then multiplied together to generate the output value 642.

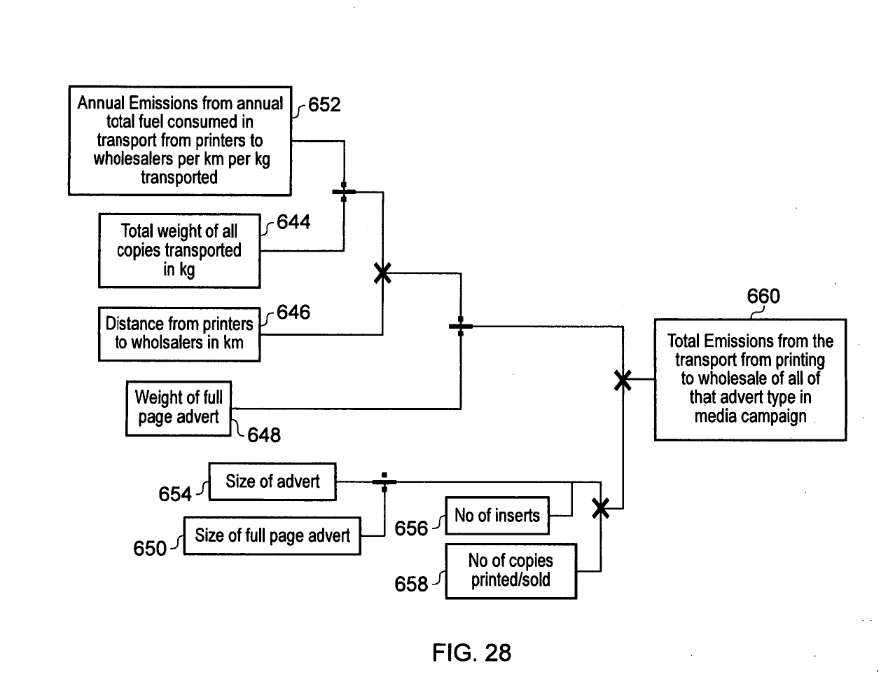

FIG. 28 illustrates a calculator associated with block 510 of FIG. 20, i.e. the distribution phase. The calculator of FIG. 28 is associated with CO2 generation resulting from transportation of adverts in press media items from the printing facility to a wholesale outlet. Specifically, the calculator of FIG. 28 is used when the annual distance travelled by the transportation vehicle is known. The calculator of FIG. 28 receives four raw data values 644 to 650, four input values 652 to 658, and produces an output value 660. The raw data value 644 is the total weight of all copies of the press media item in question transported from the printing facility to a wholesale outlet. The raw data value 646 is the distance from the printing facility to the wholesale outlet. The raw data value 648 is the weight of a full page advert. The raw data value 650 is the size of a full page advert. The input value 652 is the annual CO2 emissions resulting from fuel consumption during transportation from the printing facility to the wholesale facility per kilometre per kilogram transported. The input value 654 is the size of the advert. The input value 656 is the number of inserts. The input value 658 is the number of copies of the press media item containing the advert which are printed or sold. The output value 660 is the total CO2 emissions caused transporting from the printing facility to a wholesale outlet all of the adverts specified in the media plan. In operation, the input data value 654 is divided by raw data value 650, and the result is multiplied by input values 656 and 658. Separately, input value 652 is divided by raw data value 644, the result is multiplied by raw data value 646, and then divided by raw data value 648. The two values resulting from the above operation are then multiplied together to generate the output value 660.

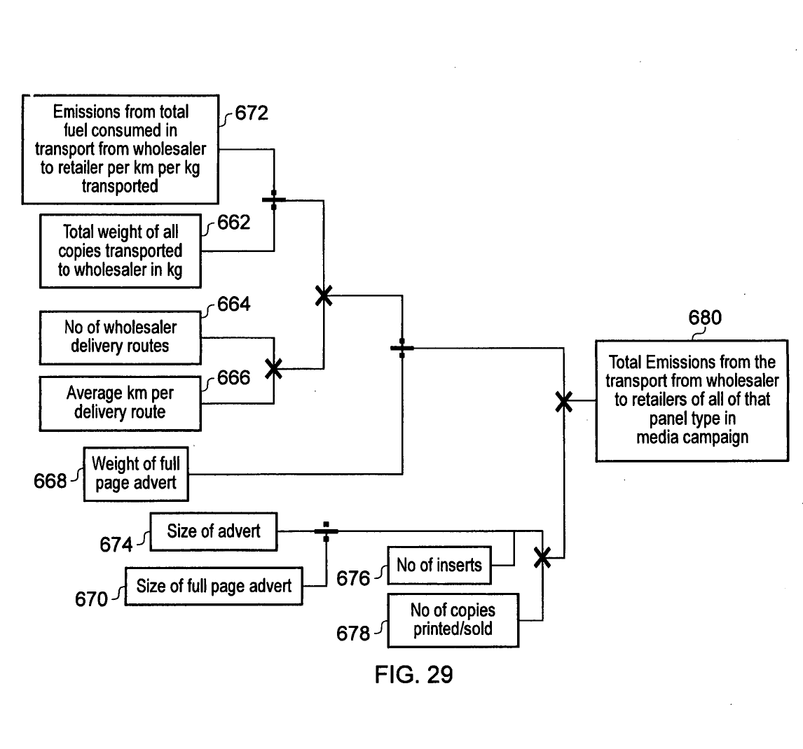

FIG. 29 illustrates a calculator associated with block 510 of FIG. 20, i.e. the distribution phase. The calculator of FIG. 29 relates to the CO2 generated in transporting press media items from a wholesale outlet to one or more retail outlets. The calculator of FIG. 29 receives five raw data values 662 to 670, four input values 672 to 678, and produces output value 680. The raw data value 662 is the total weight of all copies of the press media item including the advert, which are transported from the wholesale outlet to the retail outlets. The raw data value 664 is the number of wholesale outlet delivery routes. The raw data value 666 is the average distance of a delivery route. The raw data value 668 is the weight of a full page advert. The raw data value 670 is the size of a full page advert. The input value 672 is the CO2 emissions from fuel consumption in transporting from the wholesaler to the retailer per kilometre per kilogram transported. The input value 674 is the size of the advert. The input value 676 is the number of inserts. The input value 678 is the number of copies of the press media item containing the advert in question which are sold or printed. The output value 680 is the total CO2 emissions caused by transporting from the wholesaler to the retailers all of the adverts listed in the media plan. In operation, the input value 674 is divided by the raw data value 670, the result is then multiplied by the input values 676 and 678, to generate a first resultant value. Separately, the input value 672 is divided by the raw data value 662, the result is multiplied by the raw data values 664 and 666, and then divided by the raw data value 668, to generate a second resultant value. The first and second resultant values are then multiplied together to generate the output 680.

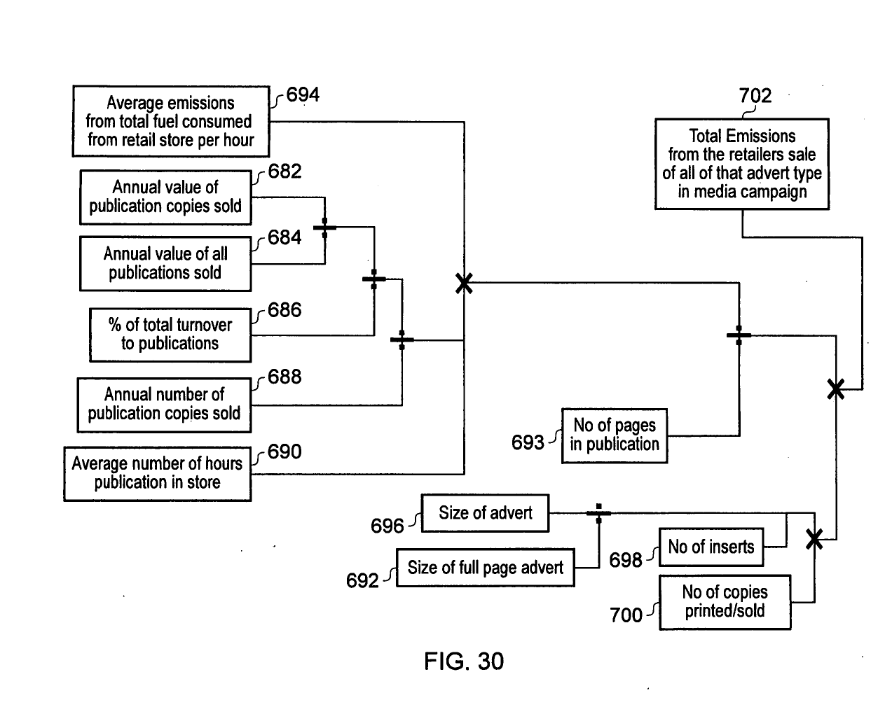

FIG. 30 illustrates a calculator also associated with block 510 of FIG. 20, i.e. the distribution phase. The calculator of FIG. 30 relates to CO2 emissions generated at the point of sale by retailers. The calculator of FIG. 30 receives seven raw data values 682 to 693, four input values 694 to 700, and produces output value 702. The raw data value 682 is the annual value from the sale of publications containing the advert. Raw data value 684 is the annual value from the sale of all publications (i.e. including those not containing the advert). Raw data 686 is the percentage of total turnover attributable to publications. Raw data value 688 is the annual number of sold publications containing the advert. Raw data value 690 is the average number of hours the publication containing the advert is in store. The raw data value 692 is the size of a full page advert. The raw data value 693 is the number of pages in the publication containing the advert. The input value 694 is the average CO2 emissions caused by the retail store per hour. Input value 696 is the size of the advert. Input value 698 is the number of inserts. Input value 700 is the number of copies of the press media item (publication) containing the advert which are printed or sold. The output value 702 is the total CO2 emissions from retailer sale of all the advert type in question specified in the media plan. In operation, the raw data value 682 is divided by the raw data value 684, the result is then divided by raw data value 686, then divided by raw data value 688, and then multiplied by raw data value 690 and input value 694. This value is then divided by raw data value 693 to generate a first resultant value. Separately, input value 696 is divided by raw data value 692, and then multiplied by input value 698 and 700, to generate a second resultant value. The first resultant value is then multiplied by the second resultant value to generate the output 702.

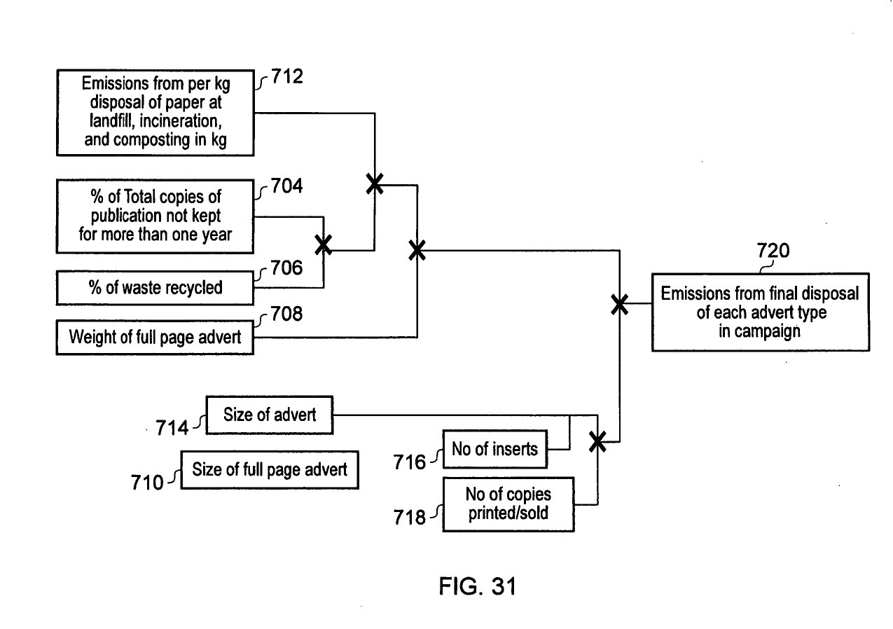

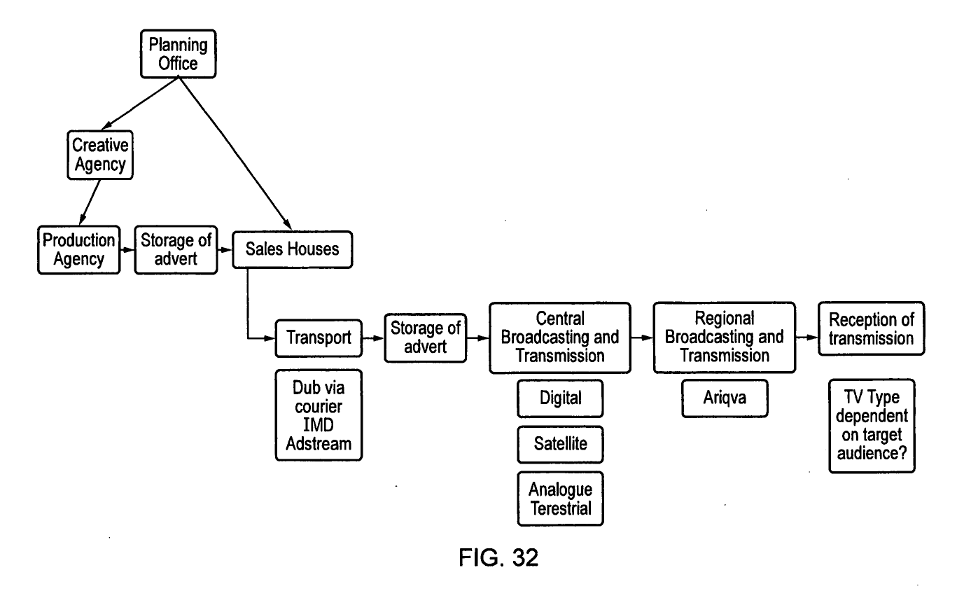

FIG. 31 illustrates a calculator associated with block 512 of FIG. 20, i.e. the disposal phase. The calculator of FIG. 31 receives four raw data values 704 to 710, four input values 712 to 718, and produces an output value 720. The raw data value 704 is the percentage of total copies of the publication not kept for more than one year. The raw data value 706 is the percentage of waste recycled. The raw data value 708 is the weight of a full page advert. The raw data value 710 is the size of a full page advert. The input value 712 is the CO2 emissions per kilogram of paper disposed at a landfill, incineration, and composting. The input value 714 is the size of the advert. The input value 716 is the number of inserts. The input value 718 is the number of copies of the publication containing the advert which are printed or sold. The output value 720 is the CO2 emissions resulting from the final disposal of each advert of the type in question which are specified in the media plan. In operation, the input value 712 is multiplied by the raw data values 704, 706 and 708. Separately, the input value 714 is divided by the raw data value 710, and the result is multiplied by the input values 716 and 718. The two values resulting from the above operation are then multiplied together to generate the output value 720.

It is noted that the above described lifecycle and calculators are specific to adverts for press media items, however, may also be suitable for other media format types. A single instance of the lifecycle may only model the CO2 emissions relating to one particular type of press advert. Different types of press adverts (e.g. ones of different size) may be modelled using other instances of the lifecycle and calculators in which the raw data values and/or input values may be changed according to the specifics of those different types.

It is to be understood that in the present example embodiment, although not shown, additional calculators, input values and raw data values may be provided for lifecycle blocks 500 to 512. Additionally, in some example embodiments, one or more of the calculators described above with reference to FIGS. 21 to 31 may be excluded. It is to be understood that typically at least one calculator is provided for each phase in the lifecycle 498. Each calculator typically receives at least one raw data value and input value, and operates on those values to calculate the CO2 emissions relating to performing a lifecycle phase in respect of particular press adverts specified in the media plan.

In a corresponding way to as stated above with reference to the outdoor media format example embodiment, the computer system 50 can load into its memory 56 the lifecycle 498 of FIG. 20. The computer system 50 can then use the calculators associated with this lifecycle 498 to calculate CO2 emissions values relating to each stage 500 to 512. The operation of the present example embodiment from this stage is analogous to the operation of the outdoor media format example embodiment described above. Therefore, Figures corresponding to above-described FIGS. 15 and 16 may be generated using data relating to the press media format rather than the outdoor media format. Accordingly, it can be seen that the present invention is equally applicable to press media formats, and is capable of calculating CO2 emissions values relating to each press media item specified in the media plan.

It is noted that the principles of the above described example embodiment relating to the press media format may be used in order to generate a further embodiment relating to a direct-mail media format. However, in such embodiments, adverting is sent directly to a user, rather than via a wholesaler and retailer and, therefore, some aspects of the distribution phase can be simplified.

FIG. 20 illustrates an exemplary series of events relating to television advertising. Television advertising refers to all advertising on digital cable, digital terrestrial, analogue terrestrial, and on-demand television. The additional information required from the user in the media plan may include any of the following: the length in seconds of the advert; whether or not the advert is part of a sponsorship (if sponsorship then the length and position of it); the time of year the advert is shown; the day of the week the advert is shown; whether the advert is shown during peak or non peak times; whether the advert is shown during the centre of a programme; the position in the break when the advert is shown; the total number of channels in which the advert is shown; the total number of advertising spots booked for the advert; whether the advert is shown regionally or nationally (if regional then which specific region, number of terrestrial channels picked, number of digital cable channels picked), the percentage of the television audience reached, the frequency with which the advert is shown. The raw data values required may include any of the following: media buyer (planning) office emissions; emissions relating to the transfer of content to broadcasters or sales houses; emissions relating to transmission by broadcasters; emissions relating to regional transmission; emissions relating to reception of transmission. The CO2 emission values produced may include any of the following: the kilograms of CO2 emitted per broadcast sent, the kilograms of CO2 per broadcast received, the kilograms of CO2 per campaign. Different television adverts can have different features which impact on how much CO2 is produced by them during an advertising campaign. Some exemplary considerations are as follows. The television advert can have different durations, such as, 30 seconds, 60 seconds, or 10 seconds. It can also be any other duration based on a 30 second index. The adverts can also vary depending on time of year of display, day of week of display, whether display is peak or non-peak, the percentage of big programmes in which it is displayed, whether or not the advert appears at the centre of the programme, and the position of the advert in the break. The effectiveness of the advert can be identified using a number of factors including, target group, the geographical cover and frequency, TVR (% of the audience), DDS (Donovan Data Systems) and BARB (broadcasters association research board). The audience of the television adverts generally falls into a number of main target groups including, adults aged 16 to 34, ABC1 adults, housewives, ABC1 housewives, and housewives with children. One factor which influences the carbon footprint of a television advert is whether or not it is transmitted as part of an analogue or digital broadcast. Specifically, an advert broadcast digitally generates a smaller carbon footprint that if it was broadcast as an analogue signal.

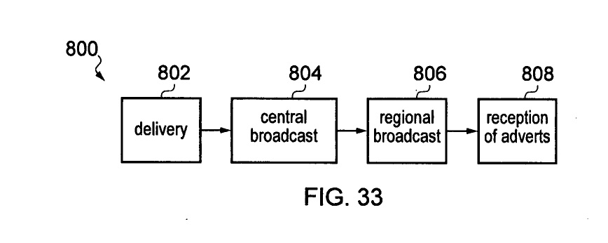

FIG. 33 provides a block diagram of a lifecycle 800 relating to television advert production. The lifecycle 800 comprises a series of phases 802 to 808, each of which will now be described in detail. It is noted that the lifecycle of FIG. 33 is analogous to that of FIG. 20 and FIG. 10 described above, however, it relates to television advertising. As before, each instance of the lifecycle 800 represents television adverts of a particular type, for example, a particular length.

The phase 802 relates to CO2 production resulting from delivery of a television advert. The phase 802 may include the CO2 generated by the planning office whilst it plans the television advert, the creative agency whilst is designs the television advert, and the production agency whilst is produces the television advert. Additionally, phase 802 may include the CO2 generated in storage of the advert. Further, phase 802 may include the CO2 generated by the sales house whilst it markets and sells the advert. Furthermore, phase 802 may include CO2 generated in transporting the sold advert to the purchaser, and storing the advert at the purchaser's location. Phase 804 relates to CO2 production resulting from central broadcast and transmission of the advert. Factors which will impact on the quantity of CO2 produced in this phase include whether the broadcast is digital, by satellite, or analogue. The phase 806 relates to CO2 production resulting from regional broadcast and transmission of the advert. The phase 808 relates to CO2 production resulting from reception of the advert at a use site, such as, via a television set. Factors which will influence CO2 production in the reception stage include the type of television used to receive the advert.

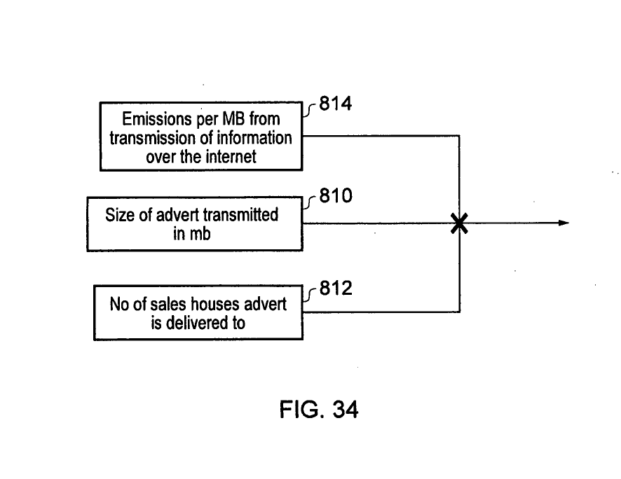

As before, a calculator is defined for each of phases 802 to 808. As discussed previously, each phase is associated with one or more calculators, and each calculator receives particular values and performs a mathematical operation on those values to generate a CO2 emission value relating to the associated lifecycle phase. Specifically, each calculator receives particular raw data values, which are stored on the hard disk 74, and input values, which are provided as part of the media plan. FIGS. 34 to 38 each specify a calculator associated with one of the stages 802 to 808.

FIG. 34 illustrates a calculator associated with stage 802 of FIG. 33, i.e. the delivery phase. The calculator of FIG. 34 receives two raw data values 810 and 812, and one input value 814. The raw data value 810 is the size of the advert transmitted in megabytes. The raw data value 812 is the number of sales houses the advert is delivered to. The input value 814 is the CO2 emissions per megabyte from transmission of information over the internet. In operation, raw data values 810 and 812 are multiplied together with input value 814 to generate an output. The output relates to the CO2 emissions generated in delivering the advert to broadcasters.

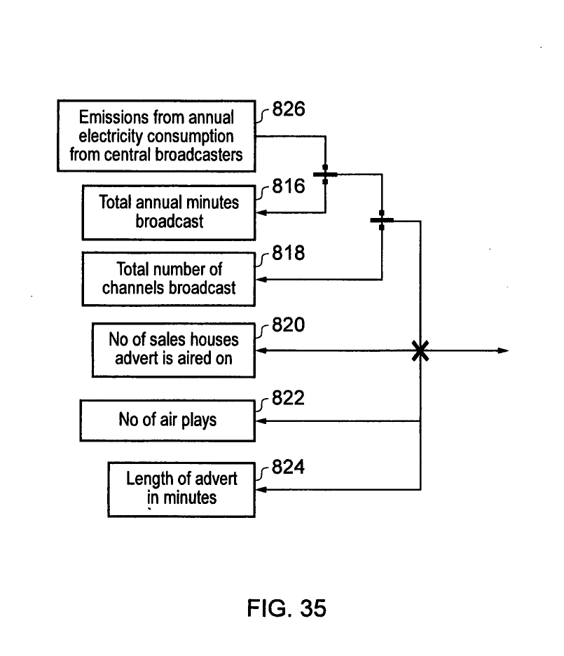

FIG. 35 illustrates a calculator associated with stage 804 of FIG. 33, i.e. the central broadcasting phase. The calculator of FIG. 35 receives five raw data values 816 to 824, and one input value 826. The raw data value 816 is the total annual minutes of advert broadcast. The raw data value 818 is the total number of channels on which the advert is broadcast. The raw data value 810 is the number of sales houses the advert is aired on. The raw data value 822 is the number of air plays of the advert. The raw data value 824 is the length of the advert in minutes. The input value 826 is the CO2 emissions from annual electricity consumption by the central broadcasters. In operation, raw data values 820 to 824 are multiplied together. Separately, input value 826 is divided by raw data value 816, and the result is divided by raw data value 818. The two resultant values generated by the above operation are then multiplied together to generate an output. The output represents the CO2 emissions generated in centrally broadcasting television adverts specified in the media plan.

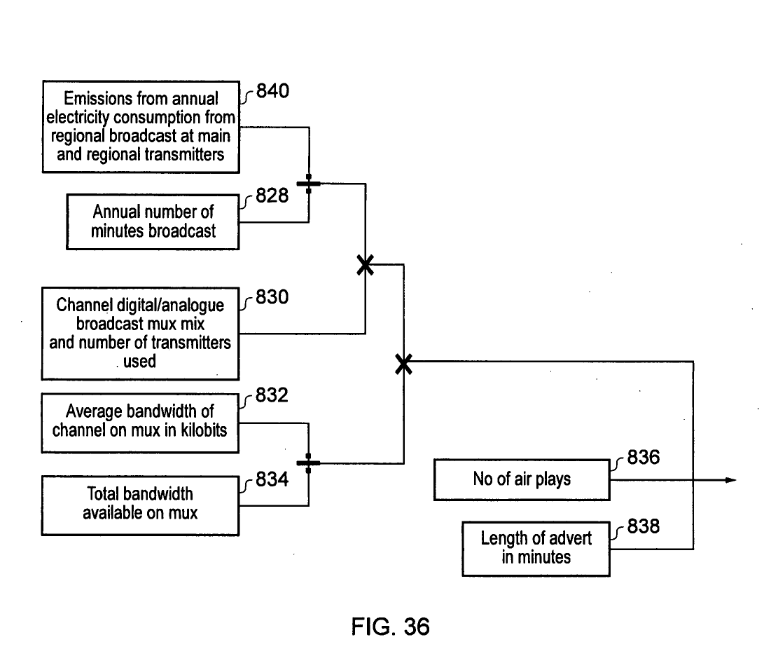

FIG. 36 illustrates a calculator associated with stage 804 of FIG. 33, i.e. the central broadcasting phase. The calculator of FIG. 36 receives six raw data values 828 to 838, and one input value 840. The raw data value 828 is the annual number of minutes broadcast. The raw data value 830 is the channel digital/analogue broadcast multiplex mix and number of transmitters used. The raw data value 832 is the average channel bandwidth on the multiplex in kilobytes. The raw data value 834 is the total bandwidth available on the multiplex. The raw data value 836 is the number of air plays. The raw data value 838 is the length of the advert in minutes. The input value 840 is the CO2 emissions from annual electricity consumption resulting from the regional broadcast at main and regional transmitters. In operation, the input value 840 is divided by the raw data value 828, the result is then multiplied by the raw data value 830 to generate a first intermediate value. Separately, the raw data value 832 is divided by the raw data value 834 to generate a second intermediate value. The first and second intermediate values are then multiplied by the raw data values 836 and 838 to generate an output value. The output value relates to the CO2 emissions generated during central broadcasting of the advert specified in the media plan.

It is noted that the calculator associated with the stage 806 of FIG. 33, i.e. the regional broadcasting phase, corresponds with the calculator of FIG. 36 described above.

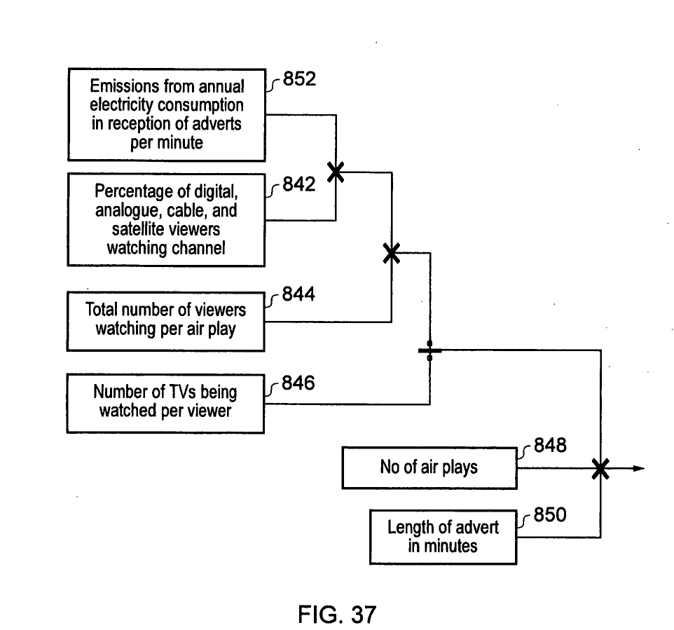

FIG. 37 illustrates a calculator associated with stage 808 of FIG. 33, i.e. the reception of adverts phase. The calculator of FIG. 37 receives five raw data values 842 to 850, and one input value 852. The raw data value 842 is the percentage of digital, analogue, cable and satellite viewers watching the channel. The raw data value 844 is the total number of viewers watching per air play. The raw data value 846 is the number of televisions being watched per viewer. The raw data value 848 is the number of air plays. The raw data value 850 is the length of the advert in minutes. The input value 852 is the CO2 emissions from annual energy consumption in reception of adverts per minute. In operation, the input value 852 is multiplied by the raw data values 842 and 844, and the result is then divided by raw data value 846. The resultant value is then multiplied by raw data values 848 and 850 in order to create an output. The output corresponds to the CO2 emitted in reception of the television advert specified in the media plan.

It is noted that the above described lifecycle and calculators are specific to television adverts, although they may be suitable for other media format types. Typically, a single instance of the lifecycle may only model the CO2 emissions relating to one particular type of TV advert. Different types of TV adverts may be modelled using other instances of the lifecycle and calculators, in which the raw data values and input values may have different values.

It is to be understood that in the present example embodiment, although not shown, additional calculators and raw data values may be designed for lifecycle blocks 802 to 808. Also, in some example embodiments, one or more of the calculators described above with reference to FIGS. 34 to 37 may be excluded. It is to be understood that typically at least one calculator is provided for each phase in the lifecycle 800. Typically, each calculator receives at least one raw data value and input value, and operates on them to generate a value for the CO2 emissions generated by performing the lifecycle phase corresponding to that calculator.

In a corresponding way to as stated above with reference to the outdoor example embodiment, the computer system 50 can load into its memory 56 the lifecycle 800. The computer system 50 can then use the calculators associated with the lifecycle 800 to calculate CO2 emissions values relating to each stage 802 to 808. The operation of the present example embodiment from this stage is analogous to the operation of the outdoor media format example embodiment described above. Therefore, Figures corresponding to above-described FIGS. 15 and 16 may be generated using data relating to the TV advertising media format rather than the outdoor media format. Accordingly, it can be seen that the present invention is equally applicable to TV advertising, and is capable of calculating CO2 emissions values relating to each type of TV advert specified in an input media plan.

The present invention can also be related to radio advertising. Radio advertising includes all advertising on analogue AM and FM and digital radio. The additional information required from the user in the media plan may include any of the following: the length in seconds of the radio advert; whether or not the advert includes a top and tail; the size in kilobytes of the advert; the transfer method; whether the advert is for digital broadcast only; whether the advert is for a national campaign or a regional campaign (if regional which regions); which sales house has been picked; which stations have been picked; the number of inserts or spots relating to the advert; the cover and frequency of the broadcast. The raw data values required may include any of the following: the media buyer (planning) office emissions; emissions relating to the transfer of content to broadcasters or sales houses; emissions relating to the transmission by broadcasters, emissions relating to regional transmission; emissions relating to reception of transmission. The CO2 emission values produced may include any of the following: the kilograms of CO2 emitted per broadcast, the kilograms of CO2 emitted per broadcast received, and the kilograms of CO2 emitted per campaign.

It is to be understood that the lifecycle and calculators described above with reference to the TV advertising embodiment are also suitable for use with the present radio advertising embodiment. Accordingly, it can be seen how embodiments of the present invention may be used to calculate a carbon footprint value relating to a proposed radio advertising campaign. Additionally, the lifecycle and calculators described above with reference to the TV advertising embodiment are also suitable for use with a cinema advertising embodiment. Accordingly, it can be seen how embodiments of the present invention may be used to calculate a carbon footprint value relating to a proposed cinema advertising campaign.

It is to be understood that some embodiments of the present invention are capable of receiving a media plan specifying each of the media formats mentioned above. These embodiments are further capable of generating CO2 emission values for each different media format in the media plan. Additionally, some other embodiments are capable of generating CO2 emission values for only a subset of the media formats mentioned above.

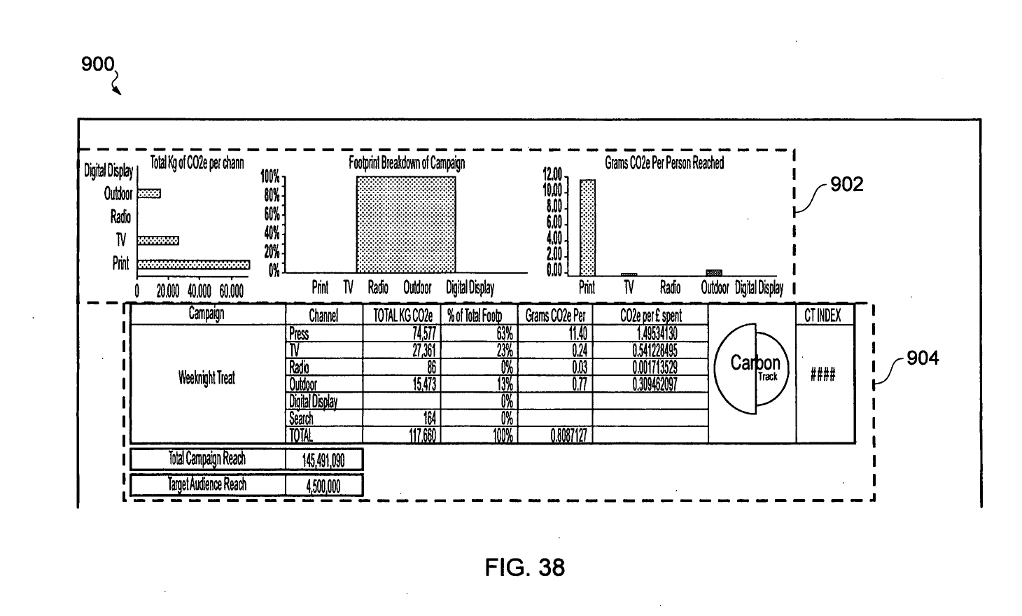

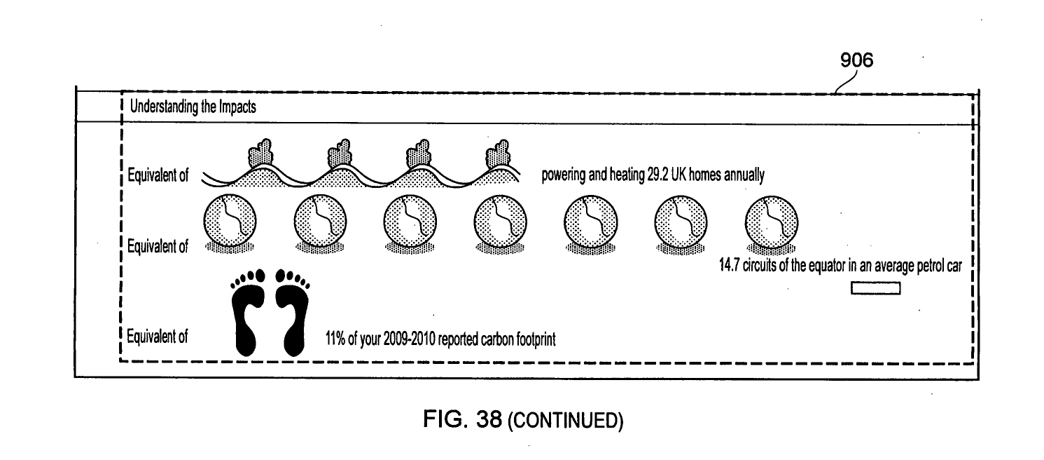

In a further embodiment of the present invention, the computer system 50 is configured to display a user interface summary screen. FIG. 38 illustrates an embodiment of an exemplary summary screen 900. The purpose of the summary screen is to summarise carbon footprint values calculated using the methods described above. Specifically, the user interface 98 of FIG. 16 relates to the outdoor media format. It is stated above that a corresponding user interface may be generated in respect of each other different type of media format specified in an input media plan. For example, a media plan may specify each of the following different media format types, paid search advertising, digital display advertising, outdoor advertising, press advertising, television advertising and radio advertising. Accordingly, a separate user interface, which corresponds to the user interface 98 of FIG. 16, may be provided for each of these media format types. The summary screen 900 aims to consolidate the information on all of these user interfaces so that carbon footprint information relating to the whole media plan can be seen and compared together. Further details of the summary screen 900 will now be described.

Summary screen 900 is delineated into multiple regions. Selections 902 and 904 comprise the first region, whereas selection 906 comprises the second region. Considering the first region, selection 902 represents carbon footprint values of the present media plan in graphical form. For example, a graph may be provided which plots a total carbon footprint value for each different media format type specified in the media plan. Specifically, the graph could plot the final value in region 118 of the user interface 98 relating to each different media format. Additionally or alternatively, a graph may be provided which plots the percentage of the total carbon footprint of the complete media plan which is attributed to each different media format specified in the media plan. Additionally or alternatively, a graph may be provided which plots, for each different media format specified in the media plan, the carbon footprint per person reached by the media format. It is to be understood that graphs could be provided which plot other carbon footprint information relating to the present media plan. The graphs may be of any type, including but not limited to, histograms, pie charts, line graphs, and scatter graphs.

The selection 904 represents carbon footprint values of the present media plan in numerical form. For example, one or more tables may be provided to numerically display the data of one or more of the graphs of selection 902. Additionally or alternatively, the data displayed numerically in selection 904 may comprise carbon footprint information relating to the present media plan which is different to the data displayed graphically in the selection 902. Additionally or alternatively, the selection 904 may provide an indicator, referred to in FIG. 38 as the ‘CT index’. The CT Index is a comparison indicator between the present media plan and one or more other media plans. Specifically, the CT Index uses a selected one or more aspects of the present media plan to compare against corresponding aspects of the one or more other media plans. For example, the CT Index may be arranged to compare the present media plan against the last media plan, and the carbon footprint of the press media format may be the only selected aspect. In this case, the CT Index would provide an indicator of whether or not the carbon footprint associated with the press media format parts of the present media plan is greater or less than the corresponding carbon footprint relating to the previous media plan. Further, the CT Index may be embodied by any feature which can indicate this comparison. For example, the CT Index may be an icon, such as, a face, which comprises a smile if the present media plan's press advertising produces a lower carbon footprint to that of the previous media plan. Alternatively, if the carbon footprint is higher than the previous media plan, the face may include a frown. The CT Index could also be a number or colour which changes according to the comparison result.

The second region of summary screen 900 comprises selection 906. The purpose of this selection is to represent the carbon footprint of the present media format in terms which make it easier to conceptualise its impact on the environment. For example, the carbon footprint of the present media plan (or a part thereof) may be quoted in terms of a weight of a commonly known thing, such as, for example, an animal, a food product or a vehicle. Additionally or alternatively, the carbon footprint of the present media plan (or a part thereof) may be quoted in terms of a volume of a commonly known thing, such as, a balloon, a building or a geographical feature (such as a lake). Additionally or alternatively, the carbon footprint of the present media plan (of a part thereof) may be quoted as equivalent to an amount of carbon dioxide generated performing a particular act, either for a certain time, or a certain number of times. For example, the carbon footprint could be quoted as being equivalent to the number of times you could travel a certain distance using a particular mode of transport, the total distance you could travel using a particular mode of transport, the number of times you could complete a certain act, or the length of time you could perform a certain act for. Additionally or alternatively, the carbon footprint could be quoted in terms of another carbon footprint, for example, a carbon footprint relating to an organisation, a building or a community. In the example of FIG. 38, the carbon footprint of the present media plan is shown in terms of the carbon footprint associated with powering and hearing an average home in the UK, and the number of circuits an average petrol car could make of the equator. Also, the carbon footprint of the present media plan is shown as a percentage of the past year's total carbon footprint. It is to be understood that embodiments of the invention are not limited to the examples used in FIG. 38.

In some example embodiments of the summary screen 900, further regions may be provided in addition to, or instead of, one or more of the above-described regions. For example, a region may be provided which displays carbon footprint data relating to one or more media plans associated with one or more different organisations to the organisation associated with the present media format. These different organisations may be peers or competitors. This data may be represented graphically, numerically or as equivalents (as described above).

Additionally or alternatively, a region may be provided which displays carbon footprint data relating to one or more previous media plans related to the same organisation that is associated with the present media plan. This data may be represented graphically, numerically or as equivalents (as described above). Additionally or alternatively, a region may be provided which displays a running total of the carbon footprint associated with media plans generated since a particular point in time. For example, all carbon footprint data relating to media plans generated in the past year may be combined to provide a measure of the total carbon footprint associated with advertising or a particular form(s) of advertising. Further, these measures may be compared to one or more budget targets to give an indication of whether or not the environmental impact of certain aspects of advertising is over or under budget. Additionally or alternatively, a notes sections may be provided so that a record can be kept of any efforts made to reduce or offset CO2 generation associated with advertising.

It is to be understood that the summary screen of the present example embodiment may have some or all of the above described features. Furthermore, it may include other measures of the environmental impact of the present media plan, or other comparisons with the environmental impact of different media plans.

In the above described example embodiments, each different media format type is associated with a particular lifecycle comprising a number of phases. Each lifecycle phase is associated with one or more calculators, and each calculator receives one or more raw data values and input values. The purpose of each calculator is to generate a measure of the CO2 generated whilst performing an act related to the creation and use of an advertisement. Considering the raw data values, in the above described example embodiments these values are stored on the hard disk 74 of the computer system 50, and are read therefrom by the calculators.

Considering the input values, in the above described example embodiments these values are input by a user with the media plan. However, in some example embodiments raw data values may optionally be input by a user, rather than being retrieved from hard disk 74. It may be desirable to input a raw data value in order to obtain a more accurate CO2 emissions value from the calculator, since the stored raw data value may only be an approximation. Further, in some example embodiments input values may optionally be retrieved from hard disk 74, rather than being input by a user. It may be desirable to retrieve an input value from the hard disk 74 in cases where a user does not know what the value is. Accordingly, default values for one or more input values are stored on the hard disk 74 and are retrieved by calculators if the user does not specify a value for them.

In the above-described embodiments of the present invention, CO2 emissions values are generated which estimate the expected CO2 emissions which will occur if a media plan is actually implemented. Accordingly, these embodiments are classified as estimated emissions embodiments. It is also within the scope of the present invention to provide embodiments which calculate the actual CO2 emissions relating to different media format types specified in a media, and the complete media plan. These embodiments are classified as actual emissions embodiments. In practice, the operation of the actual emissions embodiments is the same as their corresponding estimating embodiments. However, rather than using raw data values which approximate the CO2 emissions produced during a particular phase in the production, use or disposal of a media format, the actual CO2 emissions which were produced during that phase are determined and used. Stated differently, the actual emissions embodiments identify the carbon footprint of a media plan after it has been implemented, whereas the estimated emissions embodiments estimate the carbon footprint of a media plan before it has been implemented. An advantage of the actual emissions embodiments over the estimated emissions embodiments is that the accuracy of the CO2 emissions values is improved. Therefore, the figures are more likely to be certifiable by an environmental certification body, such as, the carbon trust. An advantage of the estimated emissions embodiments over the actual emissions embodiments is that the CO2 emissions values are available before the media plan is implemented.

Various additions and modifications will be apparent to the skilled person when reading the above disclosure any and all of which are intended to be covered by the spirit and scope of the appended claims. For example, in the above described embodiments CO2 emission values are calculated for each of the different media formats specified in the media plan. However, in some other embodiments only a proportion of the different media formats specified are used to calculate CO2 emissions values. In some other embodiments, only one media format is used to calculated CO2 emission values.

It is to be understood that the precise arrangement of the user interface for receiving a media plan, and the precise contents of the media plan, may vary between different embodiments of the present invention. For example, the user interface may be embodied as a series of dialogue boxes or as an interactive form, such as, an interactive online form. Furthermore, in some embodiments the additional information relating to the different media formats or types included in the media plan may be different to the additional information in the above-described embodiments. For example, different additional information may be included in the media plan in addition to, or as an alternative to, the additional information in the above-described embodiments. However, in any case, at least some of the additional information should relate to aspects of the media formats or types which contribute to the carbon footprint of that media format or type. Additionally or alternatively, in some different embodiments of the present invention different media formats or types may be included in the media plan in addition to, or as an alternative to, those mentioned in the above-described embodiments.

1. A method comprising:
a. storing raw data relating to a carbon footprint of a media format;
b. receiving a media plan for planning a media campaign, the media plan specifying the media format together with additional information relating to the media format;
c. performing a calculation associated with the media format, the calculation using the additional information and the raw data related to the media format, the calculation generating a carbon index which indicates the carbon footprint associated with implementing the media format in the media plan.

2. The method of claim 1, wherein the raw data relating to the media format comprises a set of raw data elements, the additional information relating to the media format comprises a set of additional information elements, and the calculation associated with the media format comprises a series of calculations, each calculation using one of the raw data elements and one of the additional information elements.

3. The method of claim 2, wherein each raw data element relates to a carbon footprint of the media format during one stage in the life of the media format, and each calculation generates a carbon index for one stage in the life of the media format.

4. The method of claim 3, wherein a calculation is provided for each stage in the lifecycle of the media format and each calculation relates to only one stage in the lifecycle.

5. The method of claim 4, wherein the lifecycle stages include at least one of the following group: planning stage, design stage, production stage, transport stage, storage stage, installation stage, use stage, disposal stage.

6. The method of claim 5, wherein the raw data elements include at least one of the following group: the carbon dioxide produced in the planning stage per media format unit, the carbon dioxide produced in the production stage per media format unit, the carbon dioxide produced in the transport stage per media format unit, the carbon dioxide produced in the storage stage per media format unit, the carbon dioxide produced in the installation stage per media format unit, the carbon dioxide produced in the use stage per media format unit, the carbon dioxide produced in the disposal stage per media format unit.

7. The method of claim 6, wherein the additional information elements include at least one of the following group: a manufacturer, a size, a quantity, a regionality, a duration, a cost.

8. The method of claim 7, wherein the carbon footprint is an amount of carbon dioxide produced.

9. The method of claim 8, wherein the raw data comprises data that estimates the carbon footprint of the media format.

10. The method of claim 8, wherein the raw data comprises data of the actual carbon footprint of the media format.

11. The method of claim 1, wherein raw data is stored relating to one or more different media formats and the media plan specifies the one or more different media formats together with additional information for the one or more different media formats, and the step of performing a calculation is performed for at least one of the one or more different media formats.

12. The method of claim 11, wherein the step of performing a calculation is performed for each of the one or more different media formats.

13. The method of claim 12, further comprising a step of combining the carbon index generated for each of the one or more different media formats to generate a carbon index for the complete media plan.

14. The method of claim 13, wherein the method further comprises comparing a generated carbon index with a corresponding carbon index relating to a different media plan, and generating an indicator which represents the result of the comparison.

15. The method of claim 13, wherein the method further comprises comparing a generated carbon index with an example carbon index, the example carbon index being related to performing a particular activity, and calculating a modified generated carbon index expressed in terms of the example carbon index.

16. An apparatus, comprising:
a. a processor
b. memory including computer program code
the memory and computer program code configured in use to, with the processor, cause the apparatus to perform at least the following:
store raw data relating to a carbon footprint of a media format;
receive a media plan for planning a media campaign, the media plan specifying the media format together with additional information relating to the media format;
perform a calculation associated with the media format, the calculation using the additional information and the raw data related to the media format, the calculation generating a carbon index which indicates the carbon footprint associated with implementing the media format in the media plan.

17. The apparatus of claim 16, further comprising a display, the apparatus being further caused to display on the display the carbon index.

18. The apparatus of claim 17, wherein the apparatus is further caused to compare the carbon index with a corresponding carbon index relating to a different media plan, and display on the display an indicator which represents the result of the comparison.

19. The apparatus of claim 17, wherein the apparatus is further caused to compare the carbon index with an example carbon index, the example carbon index being related to performing a particular activity, and display on the display a modified carbon index expressed in terms of the example carbon index.

20. A computer program, comprising:
code for storing raw data relating to a carbon footprint of a media format;
code for receiving a media plan for planning a media campaign, the media plan specifying the media format together with additional information relating to the media format;
code for performing a calculation associated with the media format, the calculation using the additional information and the raw data related to the media format, the calculation generating a carbon index which indicates the carbon footprint associated with implementing the media format in the media plan.

21. The computer program according to claim 20, wherein the computer program is a computer program product comprising a computer-readable medium bearing a computer program code embodied therein for use with a computer.

22. A computer-readable medium encoded with instructions that, when executed by a computer:
store raw data relating to a carbon footprint of a media format;
receive a media plan for planning a media campaign, the media plan specifying the media format together with additional information relating to the media format;
perform a calculation associated with the media format, the calculation using the additional information and the raw data related to the media format, the calculation generating a carbon index which indicates the carbon footprint associated with implementing the media format in the media plan.
